(19) United States
(12) Patent Application Publication
(10) Pub. No.: US 2013/0226996 A1
(43) Pub. Date: Aug. 29, 2013

(54) NETWORK TERMINAL SYSTEM AND TERMINAL DEVICE

(71) Applicant: Hitachi Consumer Electronics Co., Ltd., (US)

(72) Inventors: Tsuguo ITAGAKI, Yokohama (JP); Michihito YAMATO, Yokohama (JP)

(73) Assignee: HITACHI CONSUMER ELECTRONICS CO., LTD., Tokyo (JP)

(21) Appl. No.: 13/765,334

(22) Filed: Feb. 12, 2013

(30) Foreign Application Priority Data
Feb. 24, 2012 (JP) 2012-038153

(51) Int. Cl. H04L 29/06

(52) U.S. Cl. CPC H04L 67/42
USPC 709/203

(57) ABSTRACT

The display device has display means for displaying textual information, first text input means for entering a text string into a text input field of the display means where characters entered, and first send-receive means for sending/receiving information about the text string entered by the first text input means to/from a network. The terminal device has second send-receive means for sending/receiving the text string information sent by the first send-receive means of the display device to/from the network and second text input means for displaying the text string information received by the second send-receive means and entering a text string. The text string information is sent to the network from the second send-receive means. The display device receives text string information from the network via the first send-receive means. The received text string information is used to generate a text string that is entered by the first text input means.

### INCORPORATION BY REFERENCE

The present application claims priority from Japanese application JP2012-038153 filed on Feb. 24, 2012, the content of which is hereby incorporated by reference into this application.

### BACKGROUND OF THE INVENTION

The present invention relates to a network terminal system and terminal device.

Prior art references pertinent to the present disclosure include JP-A-2010-102412. This reference states “the display device is equipped with software keyboard creation means for creating a software keyboard. Data on the software keyboard is data on the software keyboard for entering the addresses of web sites. Furthermore, this display device has a sending means for sending the data on the software keyboard. The display device sends the data on the software keyboard to a remote controller unit via the sending means. The remote controller unit receives the data on the software keyboard and draws a picture using a software keyboard drawing means.”

The above-cited patent reference 1 discloses a method consisting of creating a software keyboard by a display device, sending data on the software keyboard to a remote controller unit, and drawing a picture by means of the software keyboard drawing means of the remote controller unit. However, in the case of the technique set forth in JP-A-2010-102412, there occurs a large amount of data because the software keyboard data is exchanged. There is the problem that display is provided with a delay since all the data cannot be obtained at a time. Furthermore, any processing necessary according to various circumstances of usage other than entry of addresses of web sites is not disclosed. Consequently, great convenience in use is not given to users.

### SUMMARY OF THE INVENTION

In order to solve the foregoing problem, the present invention adopts configurations as set forth in the appended claims.

According to the present invention, in a case where a viewer enters characters through a software keyboard while viewing and listening to a TV broadcast, the characters can be entered easily at other terminal device.

Other problems, configurations, and advantageous effects of the present invention will become apparent from the description of the following embodiments.

### BRIEF DESCRIPTION OF THE DRAWINGS

FIG. 1A is a block diagram of a network terminal system associated with a first embodiment of the present invention.

FIG. 1B is a block diagram of one TV receiver shown in FIG. 1A.

FIG. 1C is a block diagram of the wireless terminal shown in FIG. 1A.

FIG. 2A is a diagram showing the configurations of the storage and the memory of the TV receiver shown in FIG. 1C.

FIG. 2B is a block diagram of examples of the storage and the memory in the wireless terminal shown in FIG. 2A.

FIG. 3A shows one example of text string data.

FIG. 3B shows one example of 1 line of text box data.

FIG. 3C shows one example of 1 line of text box data of an input type in a shortened expression form.

FIG. 3D shows one example of 2 lines of text box data. FIG. 3E shows one example of 1 line of text box data of an input type in the form of a password.

FIG. 4A is a diagram illustrating an operational sequence performed when a software keyboard is activated by a wireless terminal

FIG. 4B is a diagram illustrating an operational sequence performed after entry of characters by a wireless terminal is complete.

FIG. 4C is a diagram illustrating an operational sequence performed when a manipulation for entering characters at a wireless terminal is interrupted.

FIG. 4D is a diagram illustrating an operational sequence performed when the attributes of a displayed text string are obtained.

FIG. 5A shows one example of screen denoting “search programs”.

FIG. 5B shows one example of screen transition effected when a new keyword is registered at the screen denoting “search programs”.

FIG. 6A shows one example of display of a text entry screen of a software keyboard of the TV receiver 1 shown in FIG. 1A.

FIG. 6B shows one example of display of the text entry screen of the TV receiver 1, and in which candidates obtained by a predictive conversion are shown.

FIG. 7 shows one example of menu screen on the wireless terminal shown in FIG. 1A.

FIG. 8A shows one example of text entry screen displayed on the wireless terminal shown in FIG. 1A.

FIG. 8B shows one example of text entry screen displayed on the wireless screen, and in which candidates obtained by a predictive conversion are shown.

FIG. 9 shows one example of a displayed keyword newly registered at a screen denoting “search programs”.

FIG. 10 illustrates browser program functions and text input program functions of the TV receiver shown in FIGS. 1A and 1B.

FIG. 11 illustrates one example of operational sequence performed when the Web is searched by a browser engine using a search text string entered as a search keyword into a search text input text box at a search site.

FIG. 12 shows one example of display of a Web content screen displayed on the TV receiver shown in FIG. 1A.

FIG. 13 shows one example of display of a text entry screen displayed on a wireless terminal associated with a second embodiment of the present invention.

FIG. 14 shows one example of text string entered into a text input field and finalized as entry of search characters.

FIG. 15 shows one example of Web screen, and in which an entered text string is displayed in a search text input text box.

FIG. 16 shows one example of text input in the text box on a Web content screen that is displayed on the TV receiver shown in FIG. 1A in accordance with a third embodiment of the present invention.

FIG. 17 shows one example of text input in a case where an ID or password is entered into the text box of the Web content screen displayed on the TV receiver.

FIG. 18 shows one example of text entry screen in a case where a password is entered at a wireless terminal

FIG. 19 shows examples of recorded program list creating program function and text input program function of a TV receiver.

FIG. 20 shows one example of display of “recorded program list” screen on a TV receiver.

FIG. 21 shows examples of ARIB (Association of Radio Industries and Business of Japan) additional characters defined in the ARIB standards.

FIGS. 22A-22C show examples of an original program title contained in program array information (service information (SI)) and actually displayed program titles.

FIG. 23 shows one example of display of a menu screen for title editing.

FIG. 24 shows one example of display of text input screen on a TV receiver, the display being provided according to a fourth embodiment of the present invention.

FIG. 25 shows one example of text input screen on a wireless terminal, the display being provided according to the fourth embodiment of the present invention.

FIG. 26 shows one example of display of modified recorded program titles together with a “recorded program list” screen.

FIG. 27 is a diagram illustrating an operational sequence performed when a software keyboard is activated on a wireless terminal in accordance with a modification of the operational sequence of FIG. 4A.

FIG. 28 shows one example of display of text input screen displayed on a wireless terminal in accordance with a modification of the method of display illustrated in FIG. 25.

FIG. 29 is a diagram illustrating an operational sequence performed when a software keyboard is activated at a wireless terminal in accordance with a modification of the method illustrated in FIG. 11.

FIG. 30 shows one example of menu screen on a wireless terminal.

FIG. 31 shows one example of display of a “remote control screen” on a wireless Terminal.

### DESCRIPTION OF THE EMBODIMENTS

The preferred embodiments of the present invention are hereinafter described with reference to the drawings.

### Embodiment 1

In the following description, a communication terminal system including TV receivers and a wireless terminal is taken as one example, each of the TV receivers having a digital broadcast receiving function of receiving digital broadcast airwaves including broadcast service information (event information) and displaying an electronic program guide (EPG) of digital broadcasts based on the received service information.

In BS digital broadcasting, CS digital broadcasting, and terrestrial digital television broadcasting run in Japan, plural transport streams (TS) are multiplexed by one transponder into one frequency channel and transmitted. The transport streams have a data structure complying with the standards of ARIB (Association of Radio Industries and Business of Japan). Broadcast service information (event information) is added as a header to an elementary stream (ES) signal carrying content data, thus forming TS packets.

The data structure of the service information complies with ARIB STD-B10 “Standards of service information for Digital Broadcasting System” that are ARIB standards. The service information consists of PSI (Program Specific Information) being transmission control information specified in MPEG (Moving Picture Expert Group)-2 system standards and SI (Service Information) for creating an EPG.

The SI (Service Information) is composed of four tables: BIT (Broadcaster Information Table), SDT (Service Description Table), EIT (Event Information Table), and TOT (Time Offset Table).

The BIT (Broadcaster Information Table) sets forth information regarding broadcast stations within a network. The SDT (Service Description Table) is separated into a TS information portion and a service information portion. The TS information portion includes a network ID for identifying a network and a TS ID (Identifier) for identifying the TS (Transport Stream).

Different network IDs are assigned to BS network, CS1 network, and CS2 network. In the case of terrestrial digital broadcasting, network IDs of different values are assigned to different broadcast stations within the same geographical area. The service information portion includes service IDs (so-called channel numbers) that are identifiers for identifying individual services (channels) within a network.

The EIT (Event Information Table) sets forth program information about each event (so-called a program), and is separated into a service information portion and an event information portion. The service information portion includes service IDs (so-called channel numbers) that are identifiers for identifying individual services (channels) within a network. The event information portion includes event IDs, event start times, event duration times, event names (so-called program titles), and event genre. The TOT (Time Offset Table) sets forth the current time.

Digital broadcasting run in Japan has been described so far. In digital broadcasting run in various nations, program information (service information) similar to the above-described service information is being transmitted. Therefore, the present invention described hereinafter can be applied to digital broadcasting run in various countries.

A first embodiment (embodiment 1) associated with the present invention is described below.

### System Configuration

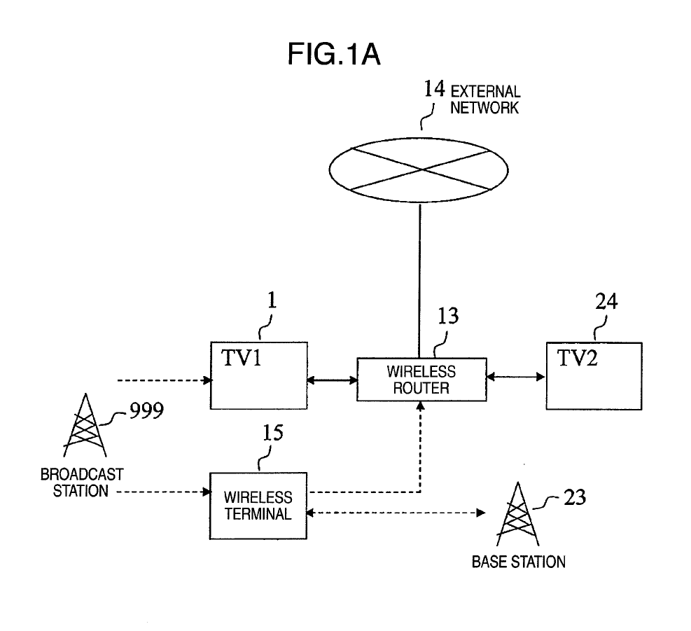

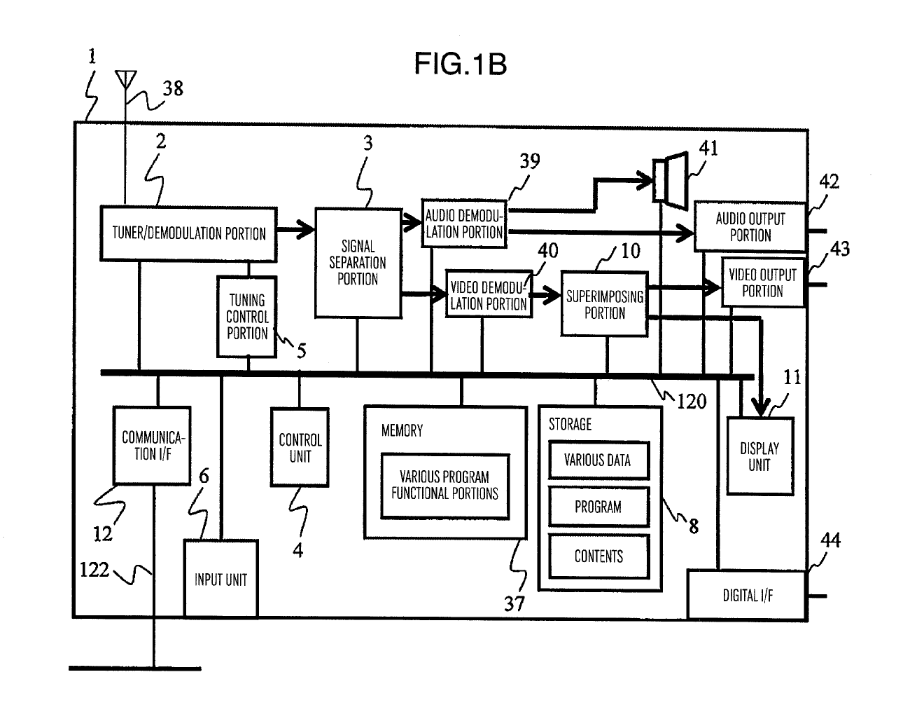

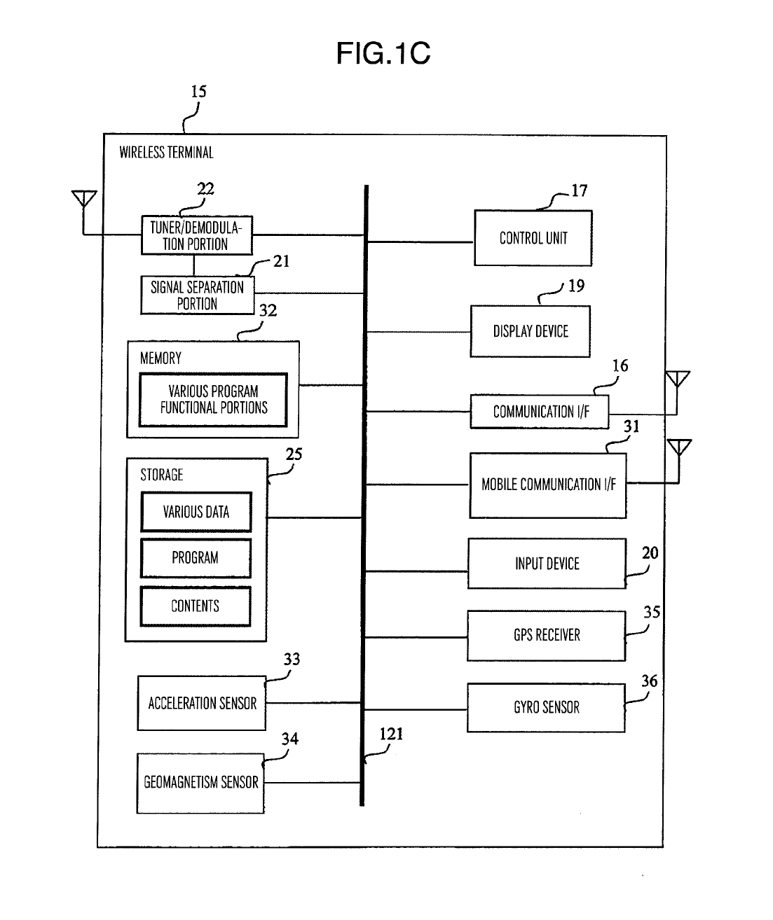

FIG. 1A is a block diagram showing one communication terminal system associated with the first embodiment. The communication terminal system of the present embodiment is made up, for example, of a TV receiver 1, a wireless terminal 15, a wireless router 13, and an external network 14. In the illustrated example, the user of the wireless terminal 15 that is a mobile communication terminal such as a cell phone or other information communication terminal is viewing and listening to a TV program on the TV receiver 1 in a home or shop while carrying the wireless terminal 15.

The wireless router 13 has wireless LAN functions such as Wi-Fi, and can be connected with the external network via a communication line. The wireless router 13 is connected with the TV receiver 1, another TV receiver 24, the wireless terminal 15, and the external network 14. The TV receiver 1, TV receiver 24, or wireless terminal 15 can obtain information from the Internet network.

It is assumed that the wireless router 13 is connected with the TV receiver 1 or 24 via a wired LAN or wireless LAN and that the wireless router 13 is connected with the wireless terminal 15 via a wireless LAN. The Wi-Fi denotes wireless LAN (Local Area Network) standards specified in IEEE (the Institute of Electrical and Electronics Engineers, Inc.—a U.S. organization) standards “IEEE 802.11a/IEEE 802.11b”.

The first embodiment associated with the present invention is further described below with reference to drawings.

### Television Receiver

FIG. 1B is a block diagram of the TV receiver 1. The TV receiver 1 is connected with an antenna 38 and includes a tuner/demodulation portion 2, a signal separation portion 3, a control unit 4, a tuning control portion 5, an input device 6, a storage 8, a memory 37, a superimposing portion 10, a display unit 11, a communication I/F 12, an audio demodulation portion 39, a video demodulation portion 40, a speaker 41, an audio output portion 42, and a video output portion 43. Their processing portions are interconnected via a bus 120.

The TV receiver 1 can store application programs in the storage 8. The control unit 4 can realize various functions by loading the programs from the storage 8 into the memory 37 and executing the programs. In the following description, for the sake of simplicity of explanation, it is assumed that the various functions realized by execution of each application program by means of the control unit 4 are implemented principally by various program functional portions.

Application programs may be previously stored in the storage 8 until the TV receiver 1 is shipped. Alternatively, such programs may be stored on a medium such as an optical medium (e.g., a CD (compact disk) or DVD (digital versatile disk)) or semiconductor memory and installed in the TV receiver 1 via a medium interface (not shown). Further, application programs can be installed after downloading the programs from the external network 14 via the communication I/F 12 and wireless router 13.

Various functions of application programs can also be realized by hardware devices operating as processing portions having the same functions. Where the functions are implemented in hardware, the functions are realized mainly by the processing portions.

The input device 6 is an input means, which accepts a user's control request to manipulate the TV receiver 1 and enters control information about input operations. For example, the input device 6 is realized by a remote control unit, a keyboard, a mouse, or other pointing device.

The control unit 4 receives user's control requests via the input device 6 and controls the blocks of the signal separation portion 3, tuning control portion 5, storage 8, superimposing portion 10, communication I/F 12, and various program functional portions.

The storage 8 is controlled by instructions from the control unit 4 and can store application programs. Furthermore, the storage 8 stores various kinds of information generated by the application programs. In addition, the storage 8 may store contents such as video/audio data streams from signals received either from the tuner/demodulation portion 2 or from the communication I/F 12.

The memory 37 is controlled by instructions from the control unit 4. The functional portions of application programs stored in the storage 8 are loaded in the memory 37.

The tuner/demodulation portion 2 tunes to a channel providing a desired service using the tuning control portion 5 to thereby receive a broadcast signal from a broadcast station 999. The tuner/demodulation portion 2 then demodulates the received broadcast signal and obtains transport streams. In the example of FIG. 1B, for the sake of simplicity of illustration, only one tuner/demodulation portion 2 is exemplified. Where the receiver has a function of making recordings simultaneously with viewing or listening or a function of viewing or listening to contents of plural channels of different transmission frequencies, the receiver may have plural tuner/demodulation portions 2. Accordingly, in the following description, all the tuner/demodulation portions 2 do not need to be identical. There may be different tuner/demodulation portions corresponding to respective processing operations.

The tuning control portion 5 receives an instruction for selecting a service (channel) via the input device 6 and controls the tuner/demodulation portion 2 according to the instruction such that the selected channel is switched. Furthermore, the tuning control portion 5 can receive instructions from various program functional portions and controls the tuner/demodulation portion 2 such that it tunes to the service (channel number) providing the currently broadcast event (program) and to the specific broadcast channel in which the service is provided.

The communication I/F 12 is connected with the wireless router 13 via a wired LAN 122 or wireless LAN. Furthermore, the communication I/F 12 has a function of communicating with the wireless router 13. In addition or alternatively, the communication I/F 12 may directly communicate with an external device without via the wireless router 13 by a method such as a wireless LAN (e.g., Wi-Fi (trademark registered)), IrDA (trademark registered), Bluetooth (trademark registered), or NFC (Near Field Communication). Each communication I/F may have a chip implementing a different communication method. A single chip treating plural communication techniques may be installed.

In the following description, the communication I/F 12 sends and receives various types of information to and from the TV receiver 24 and wireless terminal 15 via the wireless router 13. As described previously, the I/F may directly send and receive various types of information without via the wireless router 13. Furthermore, the communication I/F 12 can send and receive various kinds of information with equipment connected with an external network via the wireless router 13. For example, the I/F can receive broadcast content streams (video/audio data streams) in the form of IP broadcasts or video on demand services from the server connected with the external network. Additionally, the I/F 12 can download video streams or application programs from the server connected with the external network. The downloaded information is stored, for example, in the storage 8.

The signal separation portion 3 separates the transport streams obtained by the tuner/demodulation portion 2 or broadcast content streams obtained via the communication I/F 12 according to every kind of video data, audio data, subtitle data, and broadcast programs. Furthermore, the signal separation portion 3 has a function of obtaining program information (such as service information (SI)) and sending the information to other processing blocks. Where there is a data transmission request from other processing portion, the signal separation portion 3 sends the specified data to the requestor.

The audio demodulation portion 39 demodulates the audio data separated by the signal separation portion 3. The audio information demodulated by the audio demodulation portion 39 is output from the speaker 41. The audio information demodulated by the audio demodulation portion 39 may be output to an external device from the audio output portion 42.

The video demodulation portion 40 demodulates the video data separated by the signal separation portion 3, and the resulting video information is sent to the superimposing portion 10.

The superimposing portion 10 superimposes an EPG image, an OSD image created by any one of various program functional portions, or an image created from various kinds of information (subtitle information, captions, or data broadcasting contents) separated from the signal separation portion 3 on the demodulated video information sent from the video demodulation portion 40.

The video information delivered from the superimposing portion 10 is displayed on the display unit 11. The display unit 11 is made, for example, of a television receiver, a display device for a personal computer, or a liquid crystal panel. The video information delivered from the superimposing portion 10 may be output to an external device from the video output portion 43.

It is also possible to provide a digital I/F 44 which separates transport streams of a given program by the signal separation portion 3 and which outputs the audio and video without demodulating them.

Since various portions of the TV receiver 24 are similar to their counterparts of the TV receiver 1, their description is omitted here. In the present embodiment, the unit 1 is set forth as a TV receiver. It may be replaced by an STB (set-top box) or recorder. In this case, the speaker 41 and the display unit 11 can be omitted from the configuration of the TV receiver of FIG. 1B.

### Wireless Terminal

FIG. 1C is a block diagram of the wireless terminal 15, showing one example of its structure. The wireless terminal 15 is made up, for example, of a communication I/F 16, a control unit 17, a display device 19, an input device 20, a signal separation portion 21, a tuner/demodulation portion 22, a storage 25, a mobile communication I/F 31, a memory 32, an acceleration sensor 33, a geomagnetism sensor 34, a GPS receiver 35, and a gyro sensor 36. Their processing portions are interconnected via a bus 121.

The wireless terminal 15 stores application programs in the storage 25. Various functions can be realized by loading the programs into the memory 32 from the storage 25 by the control unit 17 and executing the programs by means of the control unit 17. In the following description, for the sake of simplicity of illustration, it is assumed that various functions realized by execution of the programs by means of the control unit 17 are implemented mainly by the various program functional portions.

Application programs may be previously stored in the storage 25 until the wireless terminal 15 is shipped. Alternatively, such programs may be stored on a medium such as an optical medium (e.g., a CD (compact disk) or DVD (digital versatile disk)) or semiconductor memory and installed in the wireless terminal 15 via a medium interface (not shown). Furthermore, application programs can be installed after downloading the programs from the external network 14 via the communication I/F 16 and wireless router 13. Additionally, application programs may be installed after downloading them from a program delivery source via both the mobile communication I/F 31 and a base station 23. Further, application programs can be installed by connecting the wireless terminal with a personal computer (PC), which has obtained the application programs via a network, via an external device connection I/F (not shown) and transferring or copying the programs from the PC to the wireless terminal 15.

Furthermore, application programs can be realized in hardware as processing portions having similar functions. In this case, the various functions are implemented mainly by the processing portions.

The communication I/F 16 is connected with the wireless router 13 via a wired LAN or the like. Furthermore, the communication I/F 16 has a function of communicating with the wireless router 13. In addition or alternatively, the communication I/F 16 may directly communicate with other device such as the TV receiver 1 or 24 without via the wireless router 13 by a method such as a wireless LAN (e.g., Wi-Fi (trademark registered)), IrDA (trademark registered), Bluetooth (trademark registered), or NFC (Near Field Communication). The communication I/F 16 sends and receives various types of information to and from the communication I/F 12 of the TV receiver 1. Also, the communication I/F 16 is connected with an external network via the wireless router 13, and sends and receives information to and from a server on the external network. Each communication I/F may have a chip implementing a different communication technique. A single chip treating plural communication techniques may be installed.

The mobile communication I/F 31 is connected with a communication network through the base station 23 by utilizing a cellular communication network such as the third-generation mobile communication system (3G) (e.g., GSM (trademark registered) (Global System for Mobile Communications)), W-CDMA (Wideband Code Division Multiple Access), CDMA2000, or UMTS (Universal Mobile Telecommunications System) or a mobile communication network such as LTE (Long Term Evolution). The mobile communication I/F 31 can send and receive information to and from a server on the communication network.

The control unit 17 receives a user's request for a manipulation via the input device 20 and controls the signal separation portion 21, display device 19, communication I/F 16, and various program functional portions.

Furthermore, the control unit 17 has a function of extracting program information from the external network 14 via the communication I/F 16 and wireless router 13 or via the mobile communication I/F 31 and base station 23, obtaining service information (SI), and passing the information to the various program functional portions.

In the present embodiment, an example in which program information about digital broadcasts is extracted by the signal separation portion 21 and the service information (SI) is obtained is described. The service information (SI) can also be acquired from the external network or program delivery source via the communication I/F 16 or mobile communication I/F 31. In this case, the signal separation portion 21 and tuner/demodulation portion 22 can be omitted from the configuration of the wireless terminal 15.

The storage 25 is controlled by instructions from the control unit 17 and can store application programs. Furthermore, the storage unit stores various types of information created by the application programs. In addition, the storage 25 may store contents such as video/audio streams from signals received from the tuner/demodulation portion 22, from the communication I/F 16, or from the mobile communication I/F 31.

The memory 32 is controlled by instructions from the control unit 17. The control unit 17 loads the functional portions of application programs stored in the storage 25 into the memory 32.

The display device 19 displays images. The displayed images may be created by application programs or may be images of the contents received via the tuner/demodulation portion 22, images received from a server on the external network via the communication I/F 16, images received from the TV receiver 1 via the communication I/F 16, or images delivered from a server on a communication network via the mobile communication I/F 31. The display device 19 may be integrated, for example, with a touch panel as described below.

The input device 20 is an input means which accepts user's manipulations on the wireless terminal 15 and which enters control information about input operations. For example, physical buttons or a touch panel can be used as the input device. In the following description of the present embodiment, an example in which a touch panel is used is described. Alternatively, various physical buttons may be used in response to various manipulative operations.

Any object (icon) on the touch panel can be moved at will by effecting a drag action (moving the object while touching it with a finger) or a flick action (flicking the object with a finger on the screen). If the object is tapped once (tap action) with a finger or tapped twice (double tap action), the object (icon) can be activated or the screen is switched to another. In the present embodiment, the above-described manipulative operations on the touch panel are referred to as drag action, flick action, and tap action.

The tuner/demodulation portion 22 and the signal separation portion 21 operate equivalently to the tuner/demodulation portion 2 and signal separation portion 3, respectively, of the TV receiver 1. Since these functions have been already described, a description of these portions 22 and 21 is omitted.

The acceleration sensor 33 measures the acceleration applied to the wireless terminal 15. The control unit 17 can know which part of the wireless terminal 15 is located at a higher position, for example, by measuring the gravitational acceleration using the acceleration sensor 33. A screen that matches how the user is holding the wireless terminal 15 can be displayed by aligning the upper side of the screen displayed on the display device 19 to the upper side found by a measurement using the acceleration sensor 33.

The geomagnetism sensor 34 measures the geomagnetism by employing a plurality of magnetic sensors.

The GPS receiver 35 receives signals sent out from a plurality of satellites by making use of GPS (Global Positioning System). The control unit 17 can computationally find the position of the wireless terminal 15 based on the signals received by the GPS receiver 35. Where the service information (SI) is obtained from a network, for example, via the communication I/F or mobile communication I/F, the control unit 17 sends positional information about the wireless terminal 15 to the transmission source of the service information (SI). The transmission source of SI can send the service information (SI) corresponding to the geographical area where the wireless terminal 15 is present to the wireless terminal 15.

The gyro sensor 36 measures the angular velocity of the wireless terminal 15 produced when the terminal is moved by the user.

### Software Configuration

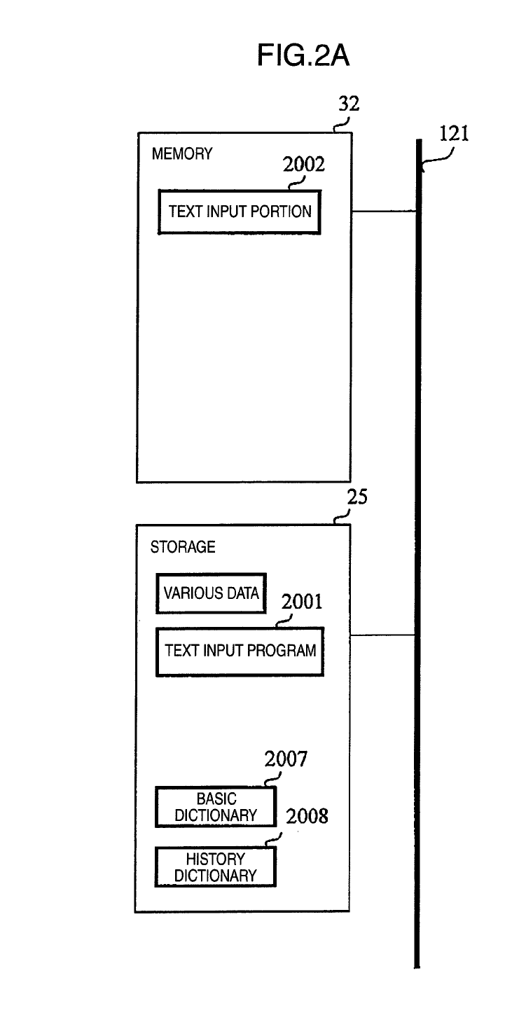

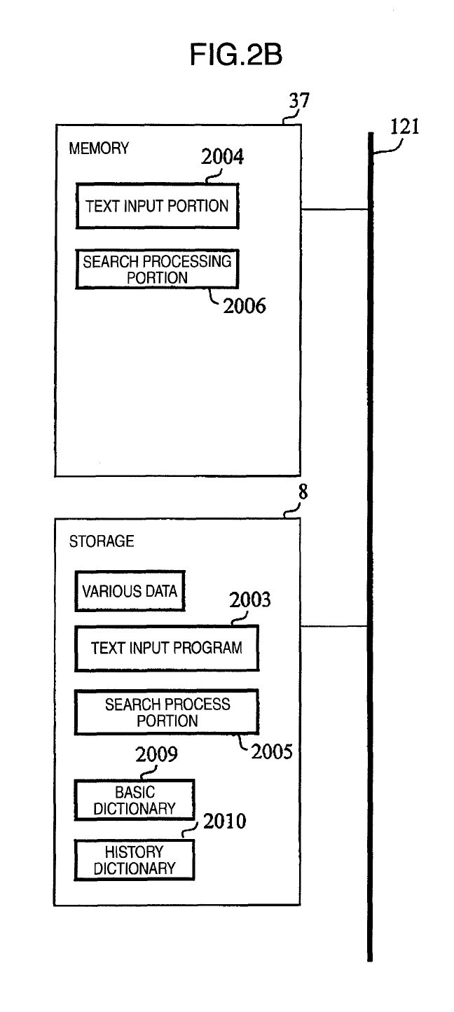

FIG. 2A is a diagram illustrating the text input program function of the wireless terminal 15. In FIG. 2A, only the storage 25 and memory 32 of the structure of the wireless terminal 15 are shown. FIG. 2A shows the state in which a text input program 2001, a basic dictionary 2007, and a history dictionary 2008 are stored in the storage 25 and in which the control unit 17 has loaded the text input program 2001 as a text input portion 2002 into the memory 32. The text input program 2001, the basic dictionary 2007, and the history dictionary 2008 may be stored in the storage 25 at the time of shipment of the product. They may be downloaded via the communication I/F 16 or mobile communication I/F 31.

When the input device 6 of the TV receiver 1 is manipulated by the user and a software keyboard is displayed on the display unit 11, the text input portion 2002 is activated interlockingly with the TV receiver 1 to permit entry of characters from the input device 6 on the wireless terminal 15.

The basic dictionary 2007 has a dictionary function of displaying candidates obtained by a predictive conversion of entered characters. The text input portion 2002 extracts candidates by a predictive conversion according to the priorities and outputs the candidates obtained by the predictive conversion to the predictive conversion-derived candidate display portion. The priorities of individual expressions are previously stored in the basic dictionary 2007.

The past history of entered characters is stored in the history dictionary 2008. When characters are entered, the text input portion 2002 extracts candidates by a predictive conversion according to priorities given by the history data and outputs the candidates to the predictive conversion-derived candidate display portion.

FIG. 2B illustrates the text input program function and search process program function of the TV receiver 1. In FIG. 2B, only the storage 8 and memory 37 of the structure of the TV receiver 1 are shown. FIG. 2B shows the state in which a text input program 2003, a search process program 2005, a basic dictionary 2009, and a history dictionary 2010 are stored in the storage 8 and that the control unit 4 has loaded the text input program 2003 and the search process program 2005 as a text input portion 2004 and a search processing portion 2006 into the memory 37. The text input program 2003, search process program 2005, basic dictionary 2009, and history dictionary 2010 may be stored in the storage 8 or in a nonvolatile memory (not shown) at the time of shipment of the product or may be downloaded via the communication I/F 12 or digital broadcast airwaves.

Where text entry is performed at the TV receiver 1, the input device 6 accepts a user's manipulation. If a text string is entered by manipulation either of a software keyboard displayed on the display unit 11 or of physical buttons, the text input portion 2004 passes text string information as search conditions to the search processing portion 2006. Where text entry is performed at the wireless terminal 15, the text input portion 2004 sends information such as the number of characters per line, the number of lines, other entry form, and effective character types as attribute information to the text input portion 2002 of the wireless terminal 15. The wireless terminal 15 makes a decision as to whether characters entered from the user are effective. Data about an effective text string is received by the TV receiver 1.

The basic dictionary 2009 has a dictionary function of displaying candidates obtained by a predictive conversion of entered characters. The text input portion 2004 extracts candidates by a predictive conversion according to priorities and outputs the candidates obtained by the predictive conversion to the predictive conversion-derived candidate display portion. The priorities are previously stored in the basic dictionary 2009 for individual expressions.

A history of already entered characters is stored in the history dictionary 2010. Where characters are entered, the text input portion 2004 extracts candidates by a predictive conversion according to the priorities indicated by the history data and outputs the candidates to the predictive conversion-derived candidate display portion.

The search processing portion 2006 obtains the service information (SI) from the signal separation portion 3 using the text string received from the input device 6 or the text string received from the input device 20 of the wireless terminal 15 as search conditions, and searches for desired programs. The result of the search satisfying the search conditions are displayed on the display unit 11 via the control unit 4.

In the present embodiment, in a case where programs that the user wants to view with the TV receiver 1 or programs of which the user wants to make recordings by scheduled recording are searched for, keywords such as genre, program title, and performers are entered. At this time, characters are entered as described below.

### Data Format

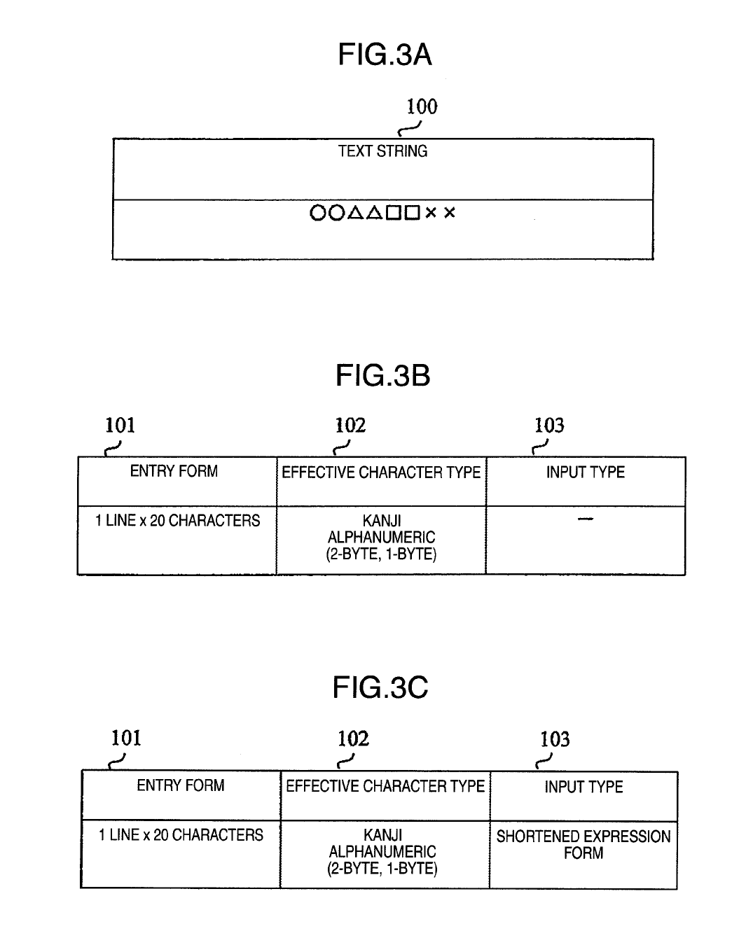

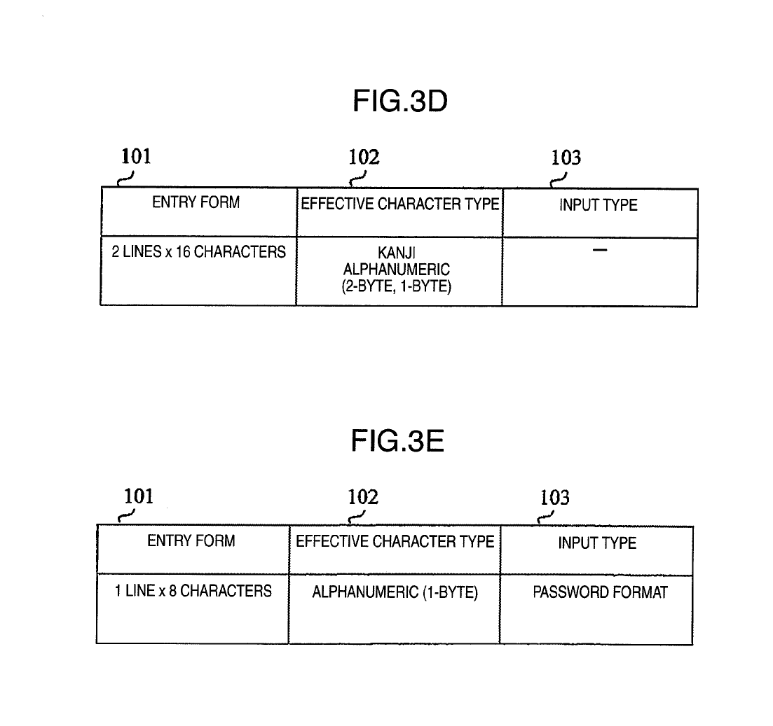

A data format associated with a network terminal system of the present embodiment is next described with reference to FIGS. 3A-3E. FIGS. 3A-3E are diagrams showing examples of data format of text string information sent from the TV receiver 1 to the wireless terminal 15 or vice versa.

FIG. 3A shows one example of text string data. FIG. 3B shows one example of 1 line of text box data. This example of data is used when a search keyword is entered. FIG. 3C shows one example of input type 103 of the 1 line of text box data, the input type being in a shortened expression form. This example of data is used to make an input in a case where an original program title such as a recorded program title is displayed in the shortened expression form because of a restriction on the number of characters for program titles. The number of characters indicated by text string data can be set greater than the number of characters specified by the entry format. When an input is made in the shortened expression form, the input type 103 is set as “shortened expression form”. A specific example of this method will be described later in connection with embodiment 4.

FIG. 3D shows one example of 2 lines of text box data. This example of data is used when sentences are entered. Where there are plural lines, a specified number of lines are set. A specific example of this method will be described later in connection with embodiment 3.

FIG. 3E shows one example in which the input type 103 of a 1-line text box is in a password format. This example is used in a case where the maximum number of English one byte characters is 8 and in which an ID or password for a Web browser screen is entered. Where a password is entered, the input type 103 is set as “password format”. A specific example of this method will be described later in connection with embodiment 3.

Text string information consists of a text string 100 and its attributes which assume the forms of entry form 101, effective character type 102, and input type 103, as shown in FIGS. 3A-3E.

The text string 100 indicates a text string entered from the input device 6 or 20. The entry format 101 indicates a maximum number of lines of characters that can be entered and a maximum number of characters that can be entered in a line. A one-line text box or plural-line text box can be displayed by setting an effective maximum number of lines and characters.

The effective character type 102 of attributes indicates the type of characters that can be entered. Where used characters are restricted to alphanumeric characters (excluding special symbols) for representing IDs and passwords, such effective character types are set. Where use of only special symbols is inhibited, the inhibited characters may be expressed as they are in the present embodiment by expanding the data format and adding the attributes of “inhibited character types” in an unillustrated manner.

The input type 103 of attributes indicate the attributes of entered characters. These are set in a case where a string of characters entered such as a password is replaced by symbols such as asterisk (*) and displayed or in a case where a text string is entered using a shortened expression form.

A case in which the character input portion 2002 of the wireless terminal 15 is activated in response to a user's manipulation of the input device 20 and characters are entered from the text input portion 2002 is next described by referring to FIGS. 1A, 2, 3, and 4.

### Operational Sequence

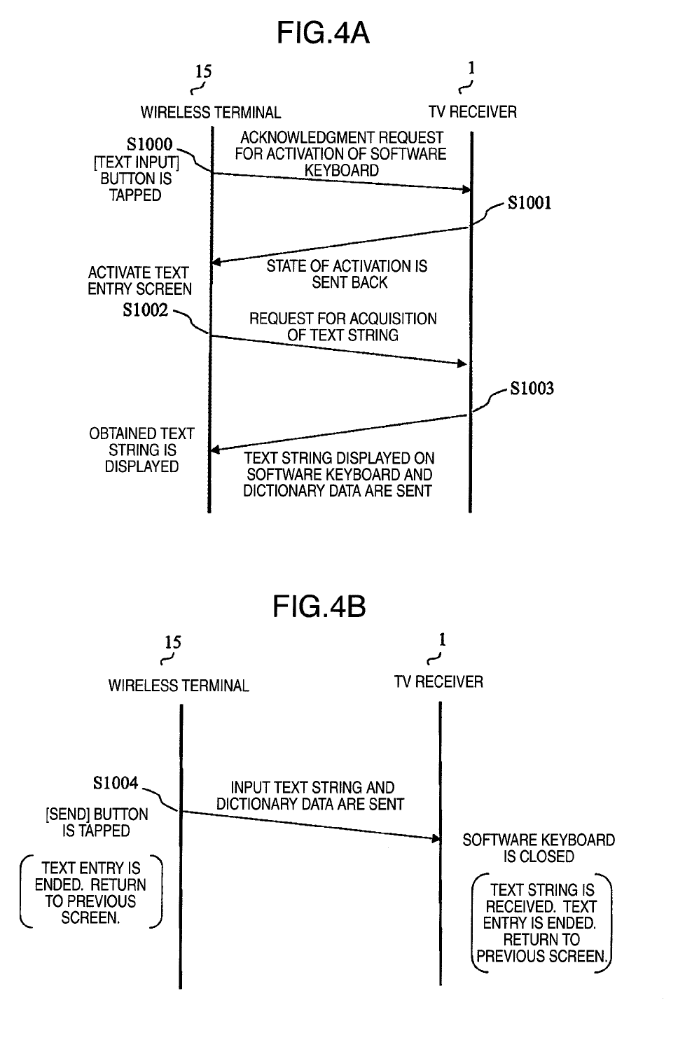

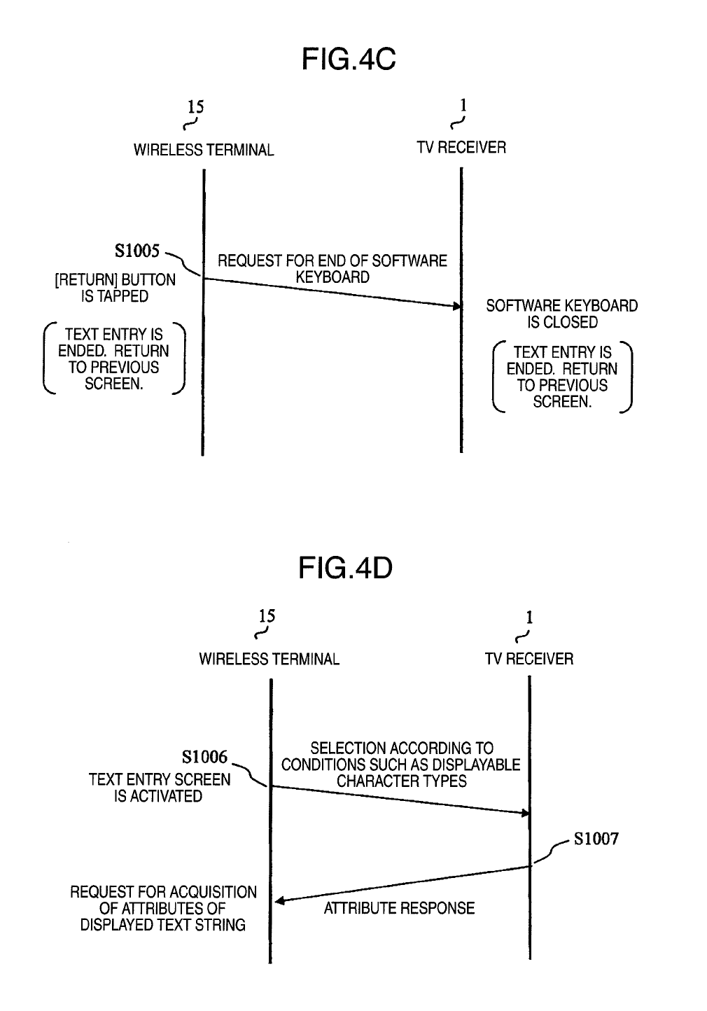

An operational sequence realized by cooperation between the text input program 2001 and each hardware device of the wireless terminal 15 and by cooperation between the text input program 2003 and each hardware device of the TV receiver 1 is described below by referring to FIGS. 4A-4B.

FIG. 4A shows one example of operational sequence performed when a software keyboard is activated by the wireless terminal 15. In the present example of operational sequence, it is assumed that the software keyboard for entry of characters is already active in the TV receiver 1.

In FIG. 4A, when a “text input” button displayed on the display device 19 is tapped (tap action; the same shall apply hereinafter) by the input device 20 of the wireless terminal 15, the text input portion 2002 sends an acknowledgment request to the control unit 4 of the TV receiver 1 via the communication I/F 16 of the wireless terminal 15 to see if the software keyboard has been activated (S1000).

The control unit 4 receiving the acknowledgment request gives a notice of the state of activation of the software keyboard to the control unit 17 of the wireless terminal 15 via the communication I/F 12 (S1001). In FIG. 4A, since the software keyboard has been activated in the TV receiver 1, a notice is given to the control unit 17 of the wireless terminal 15 to the effect that the software keyboard is active at step S1001.

The control unit 17 of the wireless terminal 15 receives the notice from the control unit 4 of the TV receiver 1. Because the software keyboard of the TV receiver 1 is active, the control unit 17 instructs the text input portion 2002 to activate the software keyboard and displays a text entry screen.

Then, the control unit 17 of the wireless terminal 15 requests the TV receiver 1 to obtain text string data via the communication I/F 16 of the wireless terminal 15 (S1002).

The control unit 4 sends text string data already entered into the software keyboard displayed on the display unit 11 and data in the basic dictionary 2009 and history dictionary 2010 to the control unit 17 of the wireless terminal 15 via the communication I/F 12 (S1003).

If no character is entered into the TV receiver 1, the sent data about a text string can be empty data or data about spaces. Alternatively, only text string data can be prevented from being sent.

The text input portion 2002 gives an instruction to display the received text string on the text entry screen of the software keyboard displayed on the display device 19. The dictionary of the TV receiver 1 and the dictionary of the wireless terminal 15 are synchronized at all times. In order to update the dictionaries when characters are entered, data in the basic dictionary 2009 and history dictionary 2010 of the TV receiver 1 are copied into the basic dictionary 2007 and history dictionary 2008, respectively, of the wireless terminal 15.

As a modification of the operational sequence illustrated in FIG. 4A, the software keyboard of the wireless terminal 15 can be activated in an interlocking manner with the activation of the software keyboard of the TV receiver 1 and a text entry screen can be displayed by omitting step S 1000 and giving a notice of the state of activation from the TV receiver 1 to the control unit 17 of the wireless terminal 15 via the communication I/F 12 (S1001).

FIG. 4B illustrates one example of operational sequence performed after entry of characters at a wireless terminal is complete. In response to a user's manipulation accepted by the input device 20, the text input portion 2002 of the wireless terminal 15 enters characters in the text entry screen of the software keyboard while referring to the basic dictionary 2007 and history dictionary 2008. Then, if a “send” button displayed on the display device 19 is tapped to determine the characters entered to the wireless terminal 15, data about the text string entered to the text entry screen of the software keyboard of the wireless terminal 15 and data in the basic dictionary 2007 and history dictionary 2008 referenced at the time of entry of the characters are sent to the control unit 4 of the TV receiver 1 from the control unit 17 via the communication I/F 16 (S1004).

The control unit 17 closes the text entry screen of the software keyboard displayed on the display device 19. Furthermore, the control unit 4 of the TV receiver 1 receives the text string data from the wireless terminal 15 and the data in the basic dictionary 2007 and history dictionary 2008, closes the text entry screen of the software keyboard, returns to the previous screen, and determines the entry of the characters. Additionally, data in the updated basic dictionary 2007 and history dictionary 2008 are copied into the basic dictionary 2009 and history dictionary 2010, respectively, and the data in the dictionary of the TV receiver 1 and the data in the dictionary of the wireless terminal 15 are synchronized.

In the example of FIG. 4B, after receiving the text string data from the wireless terminal 15, the TV receiver 1 closes the text entry screen of the software keyboard automatically. Alternatively, the characters may be kept displayed without closing the text entry screen of the TV receiver 1, and the unedited text string may be updated to a new text string received from the wireless terminal 15, permitting the text to be checked by the user. In this case, if editing is needed again, it is easy to make a transition to an editing screen. The communications traffic can be reduced by passing only differential data to and from the basic dictionary 2007 and history dictionary 2008.

FIG. 4C shows one example of operational sequence performed when manipulations for entering characters at the wireless terminal 15 are interrupted.

When the “return” button displayed on the display device 19 of the wireless terminal 15 is tapped by the user through the input device 20, the control unit 17 requests the TV receiver 1 to terminate the text entry screen of the software keyboard (S1005).

On receiving this request, the control unit 4 closes the text entry screen of the software keyboard and returns to the previous screen. Also, the wireless terminal 15 that has sent this request closes the text entry screen and returns to the previous screen.

FIG. 4D shows one example of operational sequence performed when the attributes of the displayed text string are obtained. In FIG. 4D, when the text entry screen is activated, the control unit 17 of the wireless terminal 15 requests the TV receiver 1 for the attributes of the displayed text string that are restrictive conditions (such as entry form and character type) for text entry (S1006). The control unit 4 sends the attributes of the text string to the wireless terminal 15 according to conditions such as settable entry form and character type (S1007). This operational sequence may be synchronized with the acquisition of a text string and dictionary data of FIG. 4A in obtaining the attributes of a text string.

### Examples of Screen Display

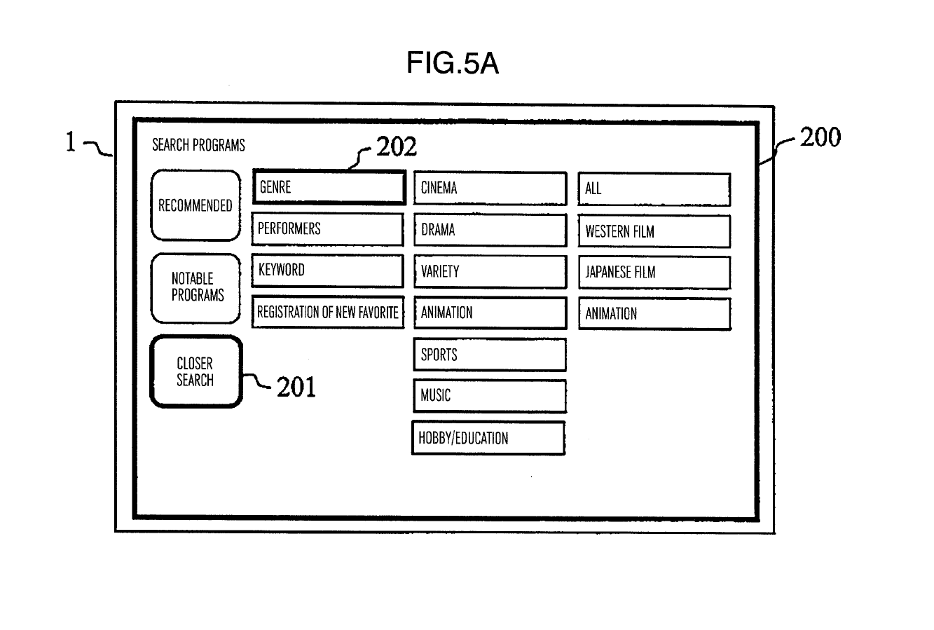

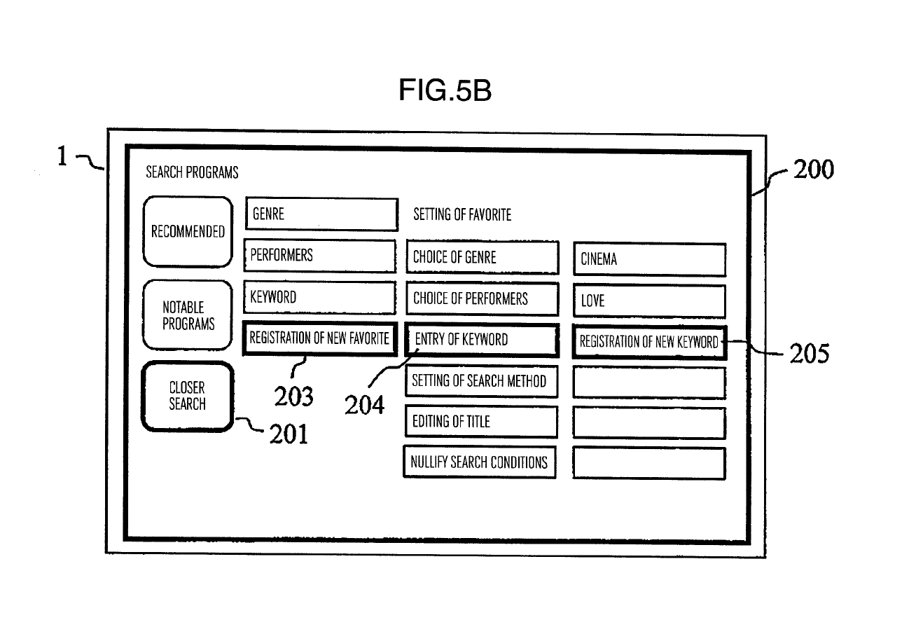

FIGS. 5A and 5B show an example of screen transition occurring when a new keyword is registered at a “search programs” screen 200.

On receiving an instruction for activating the “search programs” screen from the input device 6, the control unit 4 of the TV receiver 1 causes the search processing portion 2006 to display the “search programs” screen 200 as shown in FIG. 5A.

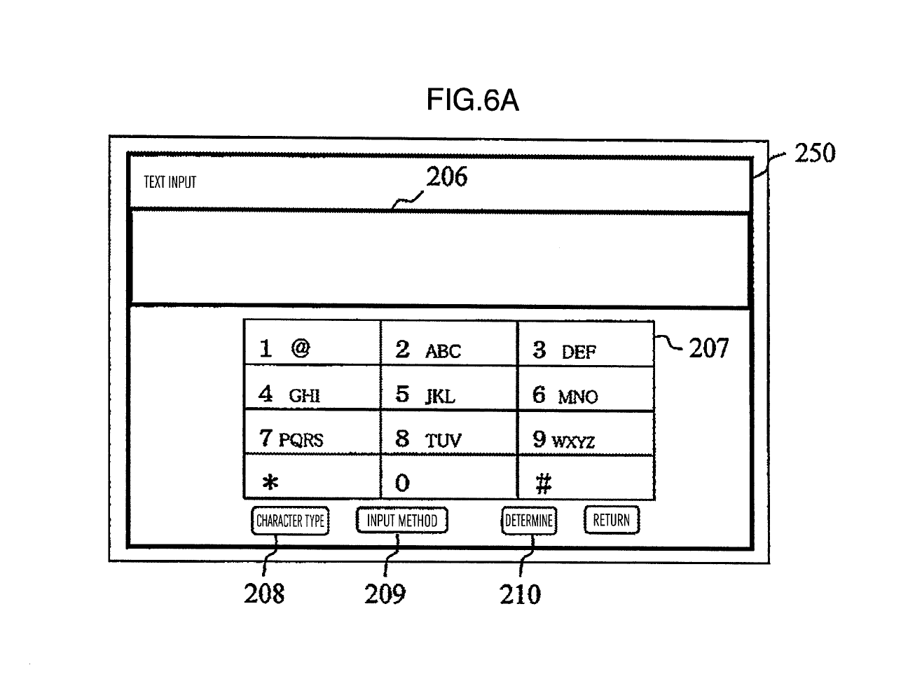

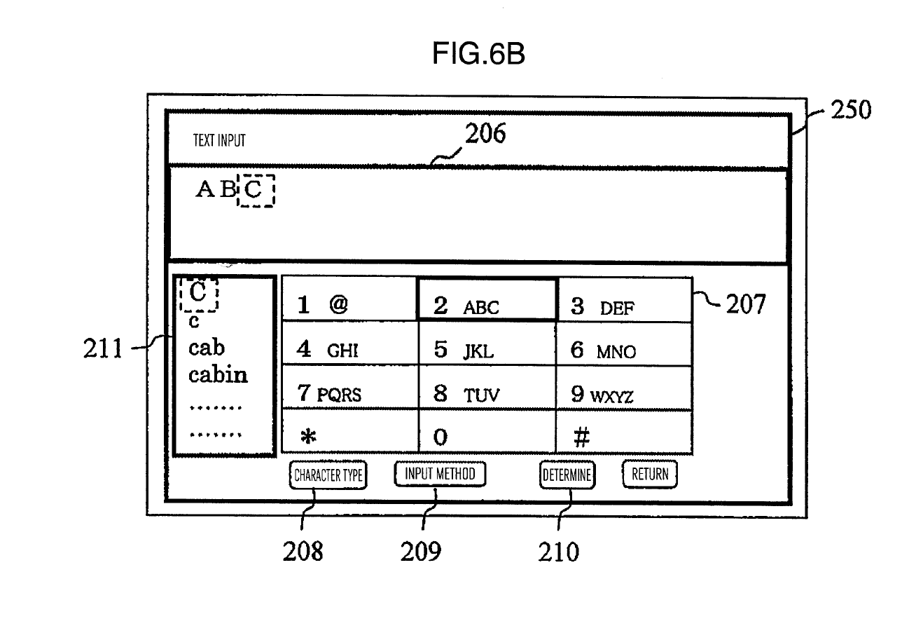

In FIG. 5A, if a “closer search” button 201 is selected through the input device 6, a “genre” button 202 is selected as an initially selected item. Then, in FIG. 5B, if a “new keyword registration” button 205 is selected in the sequence given by a “new favorite registration” 203, a “keyword entry” 204, and a “novel keyword registration” 205 through the input device 6, the control unit 4 instructs the text input portion 2004 to display a text entry screen 250 of the software keyboard shown in FIG. 6A on the display unit 11.

FIGS. 6A and 6B show examples of display of the text entry screen 250 on the software keyboard of the TV receiver 1. In FIG. 6A, the user can enter a desired text string using numeric keys 207 and the input device 6 into a text input field 206. For example, characters “A”, “B”, and “C” can be selected in this order using a “2” button. When these characters “A”, “B”, and “C” are entered, candidates obtained by predictive conversion of the entered characters or a text string is displayed on a predictive conversion-derived candidate display portion 211. The text string can be entered by selecting candidates obtained by a predictive conversion from the predictive conversion-derived candidate display portion 211 through the input device 6 and selecting a “determine” button 210.

FIG. 6B shows the state in which the character “C” is not yet determined and candidates obtained by a predictive conversion are displayed in the predictive conversion-derived candidate display portion 211 by entering and determining characters “A” and “B” in turn and finally entering “C”.

The predictive conversion-derived candidates displayed in the predictive conversion-derived candidate display portion 211 are a string of characters registered in the basic dictionary 2007 or history dictionary 2008 or both. In the example of FIG. 6B, the upper and lower case characters of “C” are displayed. In addition, words which are included in words starting at “C” and registered in the basic dictionary 2007 and which are in alphabetically higher positions are displayed. Where registered in the history dictionary 2008, frequently used ones of words which are included in words starting at “C” can be set to be displayed in higher positions.

In the present embodiment, the input method relies on a software keyboard permitting entry of alphanumeric characters using the “numeric key layout”. By selecting a “character type” button 208, the character type can be switched to “hiragana (one set of symbols used in one of the two Japanese phonetic alphabets)”, “katakana (the other set of symbols)”, and “numerals”. Also, by selecting an “input method” button 209, the input method can be switched between “numeric key layout” and “QWERTY key layout”. A case in which characters are entered from the wireless terminal 15 is next described.

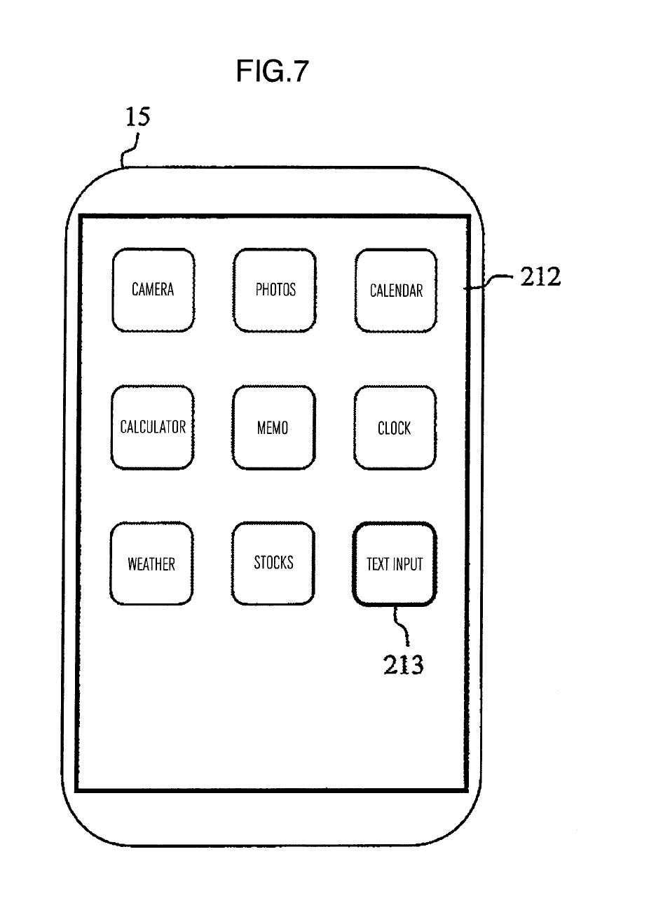

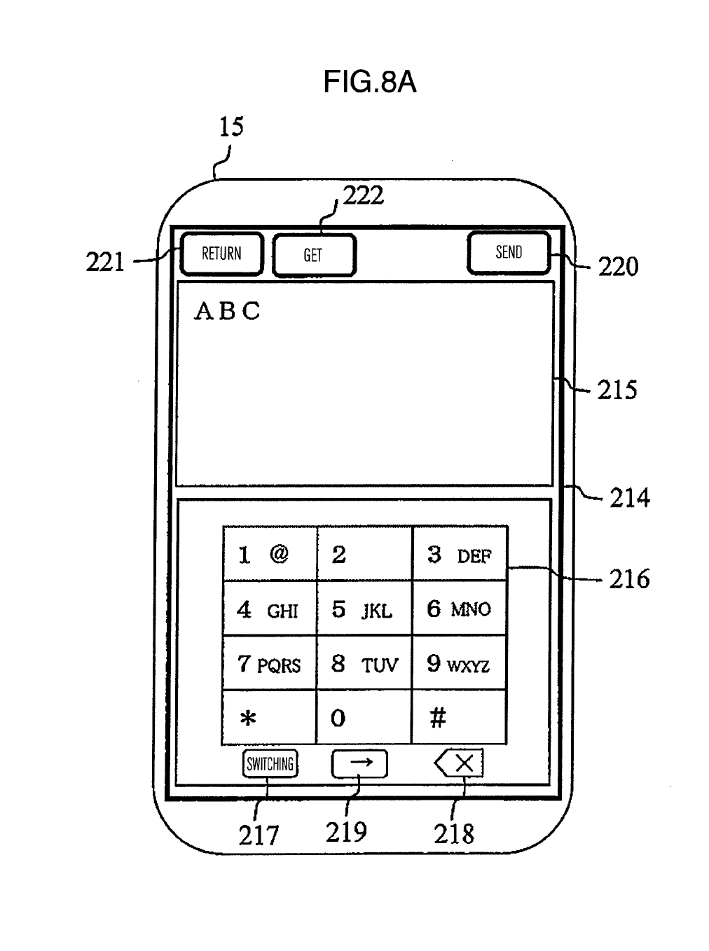

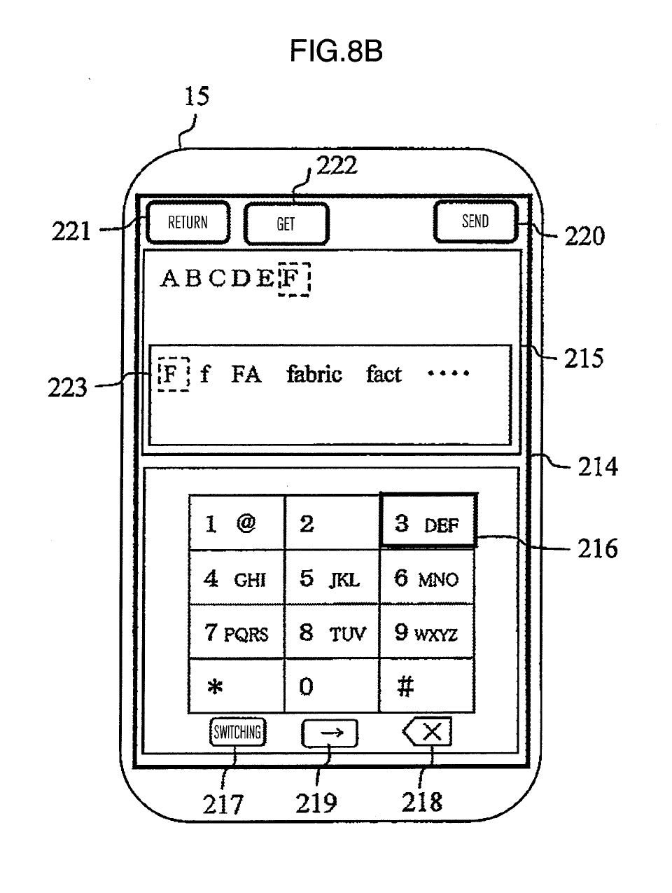

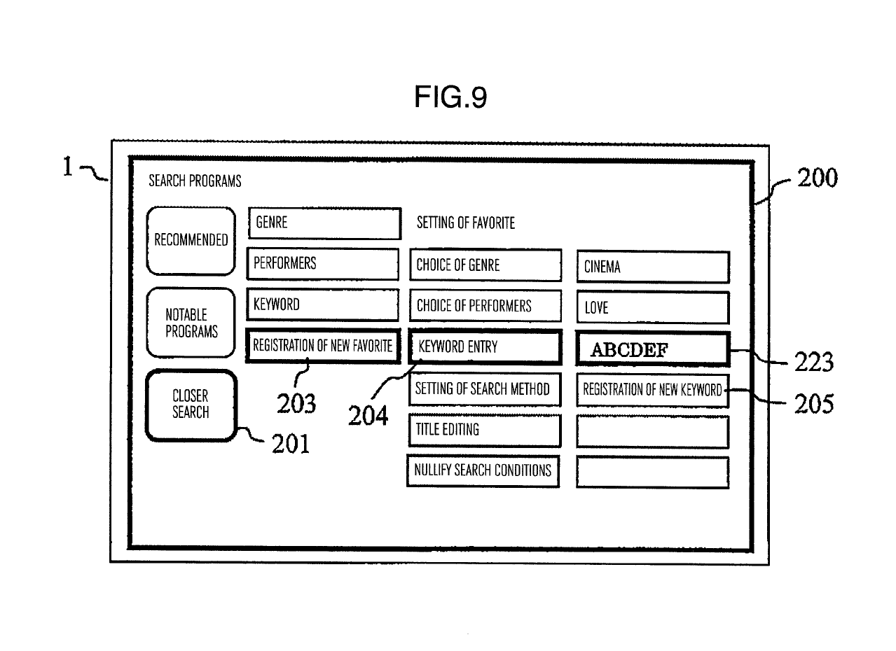

FIG. 7 shows an example of display of a menu screen on the wireless terminal 15. In FIG. 7, when a “text input” button 213 is tapped, the operational sequence illustrated in FIG. 4A is performed to display a text entry screen 214 as shown in FIG. 8A on the display device 19 of the wireless terminal 15. When it is attempted to activate the text entry screen 214 on the wireless terminal 15 earlier than activation of the text entry screen 250 of the TV receiver 1, the text entry screen on the wireless terminal 15 will be activated unsuccessfully. In this case, an error message is displayed. An “get” button 222 can be activated to obtain a text string again.

As in the above-described modified embodiment of FIG. 4A, the text entry screen 214 of the wireless terminal 15 can be displayed in an interlocking manner with activation of the text entry screen 250 of the TV receiver 1 by omitting tap action on the “text input” button 213 displayed on the menu screen of the wireless terminal 15. In this case, either method may be selected from setting menu choices in a menu screen.

FIGS. 8A-8B show examples of display of the text entry screen displayed on the wireless terminal 15. FIG. 8A shows an example of initial screen provided in a case where the wireless terminal 15 that has received text string data at step S1003 of FIG. 4A displays a text entry screen.

In FIG. 8A, the operational sequence illustrated in FIG. 4A is performed such that characters “ABC” entered in the text input field 206 of the TV receiver 1 shown in FIG. 6B are displayed in a text input field 215.

An example in which a screen is displayed in a case where a text string “DEF” is entered using numeric keys 216 through the input device 20 is next described.

FIG. 8B shows the state in which candidates obtained by a predictive conversion are displayed on a predictive conversion-derived candidate display portion 223 after characters “D” and “E” are entered in turn and determined and “F” is entered finally but in which “F” is not finalized.

In FIG. 8B, characters “D”, “E”, and “F” can be entered in this order in the text input field 215 using a “3” button. When characters “D”, “E”, and “F” are entered, candidates obtained by a predictive conversion from the entered characters or a text string is displayed on the predictive conversion-derived candidate display portion 223. Desired ones of the predictive conversion-derived candidates can be selected from the predictive conversion-derived candidate display portion 223 through the input device 20 by performing tapping actions. Thus, a string of characters can be entered.

A text string registered in the basic dictionary 2009 or in the history dictionary 2010 or in both is displayed as predictive conversion-derived candidates displayed on the predictive conversion-derived candidate display portion 223. In the example of FIG. 8B, the upper and lower case characters of “F” are displayed. In addition, words which are included in words starting at “F” and registered in the basic dictionary 2009 and which are in alphabetically higher positions are displayed. Where registered in the history dictionary 2010, frequently used ones of words which are included in words starting at “F” and registered in the history dictionary 2010 can be set to be displayed in higher positions.

In the description of the present embodiment, the input method relies on a software keyboard permitting entry of alphanumeric characters using the “numeric key layout”. By tapping a “switching” button 217, the character type can be switched to “hiragana”, “katakana”, and “numerals”. Also, the input method can be switched as in the example of character entry of the TV receiver 1 between “numeric key layout” and “QWERTY key layout” in an unillustrated manner. A “delete” button 218 is used when the last entered character is deleted. One character can be deleted at a time by performing a tapping action. Furthermore, when a character assigned to the same button in the numeric key layout method is entered in succession, the cursor can be shifted to the right by tapping a “rightward motion of cursor” button 219.

Operations performed after completion of entry of a text string “ABCDEF” into the text input field 215 are next described.

In FIG. 8B, when the “send” button 220 in the text entry screen 214 is tapped to determine the entry of characters on the wireless terminal 15, the operational sequence illustrated in FIG. 4B is performed to send the text string “ABCDEF” entered in the text input field 215 of the wireless terminal 15 and the dictionary data to the TV receiver 1. Upon receiving the text string and dictionary data from the wireless terminal, the control unit 4 closes the text entry screen 250 of the software keyboard, returns to the previous screen as shown in FIG. 9, and determines the entry of the characters into the TV receiver 1.

When the “send” button 220 in the text entry screen 214 is manipulated, if the text entry screen on the TV receiver 1 is not fully activated for some reason or other, an error message may be displayed on the display unit of the wireless terminal 15 according to the content of the response from the TV receiver 1 in the operational sequence of FIG. 4B and transmission of the text string may be interrupted.

As described already in connection with FIG. 4C, where entry of characters is interrupted, the text entry screen of the software keyboard can be closed and the previous screen can be returned by selecting a “return” button 221.

FIG. 9 shows an example of display of a newly registered keyword on the “search programs” screen 200. The newly registered keyword, 223, is assumed to be the same text string “ABCDEF” as the text string displayed on the text entry screen of the wireless terminal 15 and displayed on the “search programs” screen 200.

In this way, where characters are entered at the TV receiver, the characters can be easily entered at the wireless terminal Even where other menu choice button exemplified in FIG. 9 is selected, if it is necessary to enter characters, characters entered from the wireless terminal 15 can be sent to the TV receiver 1 by the above method.

### Embodiment 2

A second embodiment (embodiment 2) associated with the present invention is hereinafter described with reference to FIGS. 1A, 2A, 6A, 7, and 10-15. The following description of the present embodiment is made by emphasizing the difference in comparison with the first embodiment.

### System Configuration

In the present embodiment, a network terminal system is made up of a TV receiver 1, a wireless terminal 15, a wireless router 13, and an external network 14 in the same way as in the first embodiment described in connection with FIG. 1. Since the TV receiver 1 and wireless terminal 15 are identical in configuration with their counterparts of the first embodiment, their description is omitted.

### Software Configuration

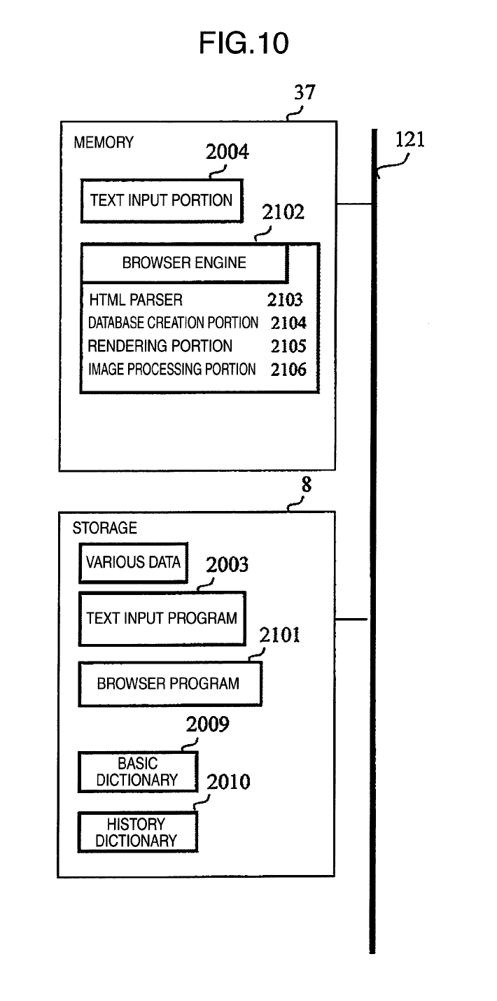

FIG. 10 shows examples of browser program function and text input program function of the TV receiver 1. In FIG. 10, only the storage 8 and memory 37 of the structure of the TV receiver 1 associated with the second embodiment are shown. FIG. 10 shows the state in which a browser program 2101 and a text input program 2003 are stored in the storage 8 and in which the control unit 4 has loaded the browser program 2101 and the text input program 2003 as a browser engine 2102 and a text input portion 2004 into the memory 37. The browser program 2101 and text input program 2003 may be stored in the storage 8 at the time of shipment of the product. Alternatively, they may be downloaded via the communication I/F 12 or via digital broadcast airwaves.

When the input device 6 is manipulated by the user and a text string is entered through the software keyboard displayed on the display unit 11 or through physical buttons, the text input portion 2004 passes information about the text string to the browser engine 2102 using the text string information as search conditions. Where a text entry is made at the wireless terminal 15, the text input portion 2004 sends entry forms (such as the number of input characters of the input string of characters and the number of lines), attribute information (such as effective character types), search candidate list information from a search site to the wireless terminal 15. The wireless terminal 15 makes a decision as to whether the characters entered from the user are effective. The TV receiver 1 receives data about the effective text string. A basic dictionary 2009 and a history dictionary 2010 are stored in the storage 8.

The search candidate list information derived from the search site is used in preference to data obtained from the basic dictionary 2009 or from the history dictionary 2010. When there is no search candidate list, data in the basic dictionary 2009 or in the history dictionary 2010 is used.

The browser engine 2102 is made up of several functional blocks, i.e., an HTML parser 2103, a database creation portion 2104, a rendering portion 2105, and an image processing portion 2106, as shown in FIG. 10.

The HTML parser 2103 analyzes the logical structure of the HTML data obtained via a network control portion and via a tuning control portion 5. Furthermore, the parser can interpret the obtained HTML data and convert it to internal data to be used by the TV receiver 1.

The database creation portion 2104 creates a database about the HTML data structure.

The rendering portion 2105 creates a layout structure including information in an expression form determined by each tag based on the database, and generates a browser display screen according to received data representing sizes, positions, and images based on the layout structure.

The image processing portion 2106 converts the obtained image file into image data in a bitmap format based on image file information such as arrangement and image file names contained in the image file specified by image tags in the HTML data.

The storage 25 and memory 32 of the structure of the wireless terminal 15 are similar to their counterparts shown in FIG. 2A and so their description is omitted.

In the present embodiment, a search is made through the TV receiver 1 at a Web content search site using a keyword. The manner in which characters are entered when the search keyword is input is described.

### Operational Sequence

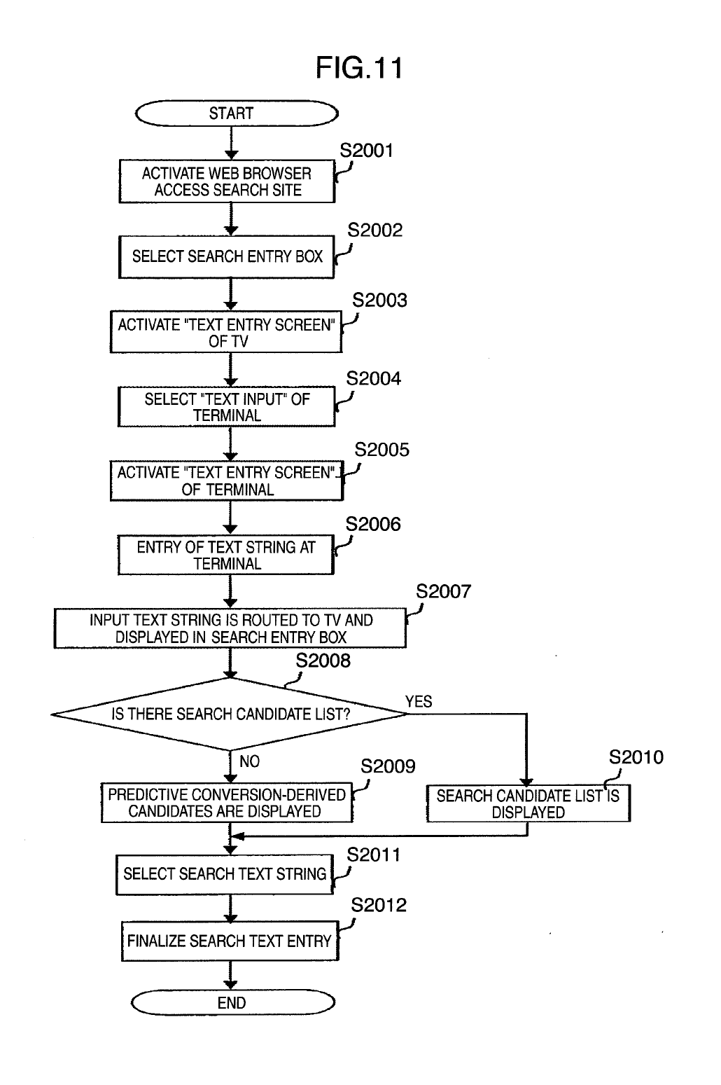

An operational sequence realized by cooperation between the text input program 2001 and each hardware device of the wireless terminal 15 and by cooperation of the text input program 2003 and browser program 2101 with each hardware device of the TV receiver 1 is described below by referring to FIG. 11.

FIG. 11 illustrates one example of operational sequence performed when the browser engine 2102 searches the Web using a search text string entered as a search keyword into the search text input box at a search site.

When an instruction for activating a browser is received through the input device 6, the control unit 4 activates the browser engine 2102. The browser engine 2102 accesses the URL of a search site that has been previously set as a homepage (S2001).

Then, the browser engine 2102 sends a request message that requests for resources for Web contents based on HTTP from a server specified by the URL of the search site that has been previously set as a homepage on a network via the control unit 4, communication I/F 12, and external network 14.

The server specified by the URL creates a response corresponding to the received request message and sends it back. The response message sent back is entered into the browser engine 2102 via the external network 14. HTML documents are embedded in the response message. The HTML parser 2103, data base creation portion 2104, rendering portion 2105, and image processing portion 2106 of the browser engine 2102 cooperate to create a browser display screen 300 and displays it on the display unit 11 (S2001).

A case in which the input device 6 is manipulated by the user and a search is made using a keyword by entering characters is next described.

When a search text input text box of a search site is selected through the input device 6 (S2002), the control unit 6 of the TV receiver 1 instructs the text input portion 2004 to activate the software keyboard and displays the text entry screen on the display unit 11 (S2003).

Then, when a “text input” button displayed on the display device 19 is tapped by the input device 20 of the wireless terminal 15 (S2004), the control unit 17 of the wireless terminal 15 instructs the text input portion 2002 to activate the software keyboard and to display the text entry screen on the display device 19 (S2005).

If characters are entered into the text input field at the wireless terminal 15 (S2006), the text input portion 2002 sends the entered string of characters to the control unit 6 of the TV receiver 1 via the communication I/F 12. The control unit 6 instructs the browser engine 2102 to display the received string of characters in the search input box that is displayed on the display unit 11 of the TV receiver 1 (S2007).

Furthermore, the control unit 6 instructs the browser engine 2102 to send the received string of characters to the search site. The server of the search site sends back search candidate list information associated with the received string of characters to the browser engine 2102.

The control unit 6 sends the search candidate list information received by the browser engine 2102 to the control unit 17 via the communication I/F16 of the wireless terminal 15. If there is search candidate list information (YES at S2008), the control unit 17 displays a search candidate list in the character input field of the wireless terminal 15 (S2010). If there is no search candidate list information (NO at S2008), the control unit 17 displays a predictive conversion-derived candidates in the text input field using the data in the basic dictionary 2009 and history dictionary 2010 (S2009).

Then, the text input portion 2002 receives a choice of a search text string from the search candidate list or predictive conversion-derived candidates through the input device 20 (S2011) and determines the entry of the search characters (S2012).

### Example Screen Display

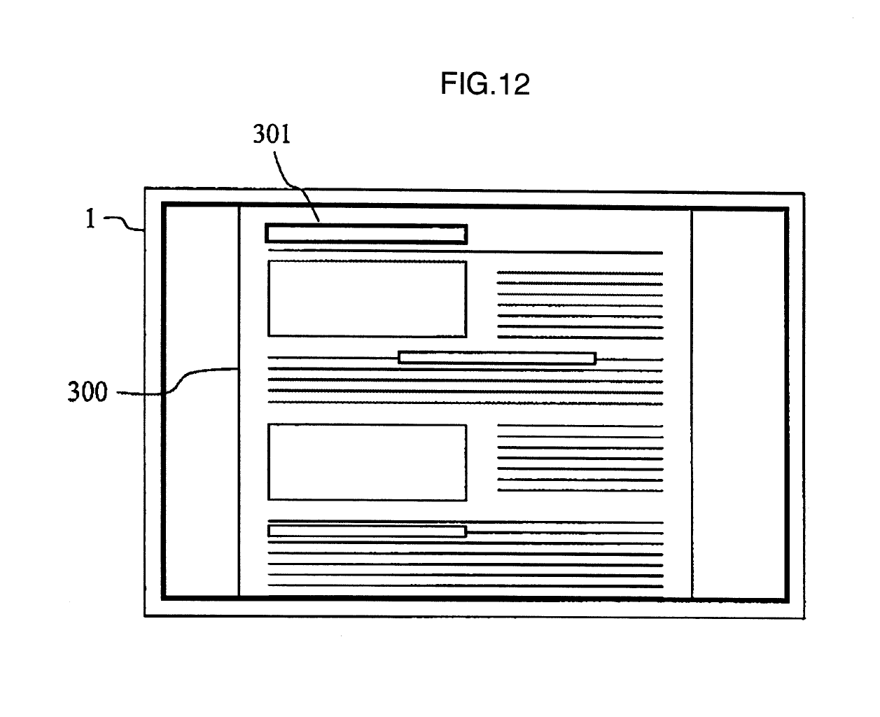

A case in which a screen is displayed when the input device 6 displays Web contents on the TV receiver 1 in response to a user's manipulation and the Web is searched is next described. FIG. 12 is an example of display of a Web content screen displayed on the TV receiver 1. The browser is activated and gain access to the URL of a search site that has been previously set as a homepage as an example. The browser screen 300 is displayed on the display unit 11.

A case in which characters are entered when the input device 6 responds to a user's manipulation and a search is made using a keyword is next described.

In FIG. 12, if the search text input text box 301 is selected through the input device 6 and a determining operation is performed, the control unit 4 instructs the text input portion 2004 to display the text entry screen 250 of a software keyboard on the display unit 11 as shown in FIG. 6A.

In FIG. 6A, a string of characters that the user wants to have can be created in the text input field 205 using numeric keys 207 through the input device 6, in the same way as in the first embodiment. A case in which characters are entered from the wireless terminal 15 is next described.

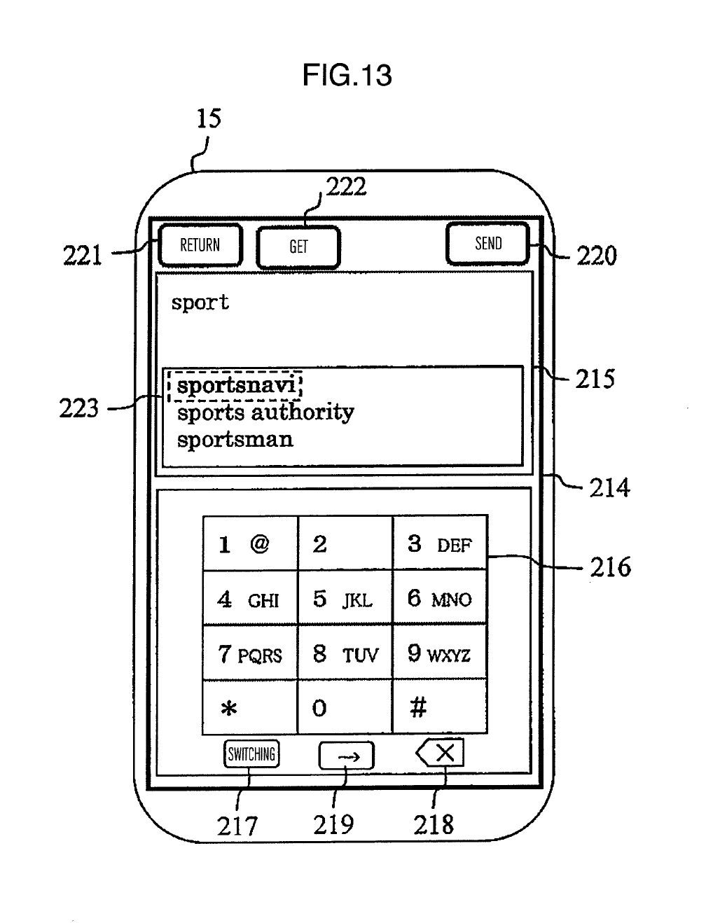

In FIG. 7, when the “text input” button 213 is tapped, a text entry screen 214 as shown in FIG. 13 is displayed on the display device 19 of the wireless terminal 15 by steps S2004-S2005 of the operational sequence of FIG. 11. As in the above-described modified embodiment of FIG. 4A, the text entry screen 214 of the wireless terminal 15 can be displayed in an interlocking manner with activation of the text entry screen 250 of the TV receiver 1 by omitting tap action on the “text input” button 213 displayed on the menu screen of the wireless terminal 15. In this case, either method may be selected from setting menu choices in a menu screen.

FIG. 13 shows an example of display of the text entry screen displayed on the wireless terminal 15 associated with the second embodiment.

In FIG. 13, there is shown an example of screen display in a case where “sports” is entered as a string of search characters into the text input field 215 using the numeric keys 216 through the input device 20.

The search text string “sports” is sent to the control unit 6 of the TV receiver 1 through the communication I/F 12. The control unit 6 instructs the browser engine 2102 to send the received text string to the search site. The server of the search site sends back search candidate list information associated with the received text string to the browser engine 2102.

The control unit 6 sends the search candidate list information received by the browser engine 2102 to the control unit 17 via the communication I/F 16 of the wireless terminal 15. The control unit 17 passes the search candidate list to the text input portion 2002 and displays the list on the search candidate list display portion 223 of the text entry screen 214.

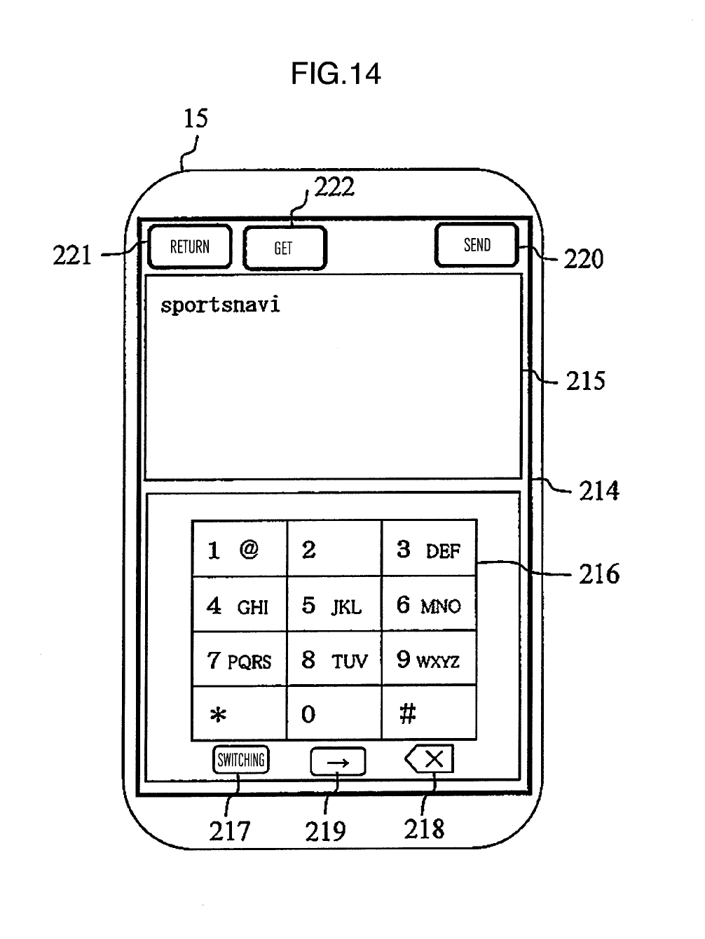

In the present embodiment, it is assumed that candidates “sportsnavi”, “sports authority”, and “sportsman” are displayed on the search candidate list display portion 223. If the input device 6 is manipulated by the user and “sportsnavi” is selected from the search candidate list by a tapping action, “sportsnavi” is entered into the text input field 215 shown in FIG. 14 and determined as a search text entry.

FIG. 14 shows one example of a finalized string of characters out of search characters entered in the text input field 215.

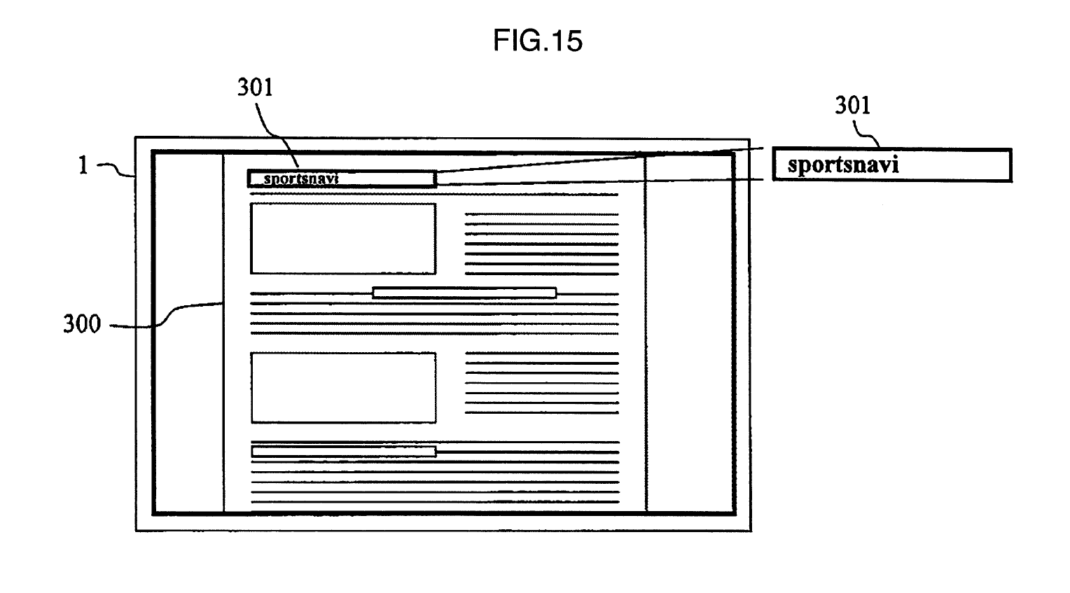

Referring to FIG. 14, if the “send” button 220 on the text entry screen 214 is tapped, the operational sequence illustrated in FIG. 4B is performed to send text string data including text string “sportsnavi” entered in the text input field 215 of the wireless terminal 15 to the TV receiver 1, where the string is displayed in the search text input text box 301 shown in FIG. 15.

FIG. 15 shows an example of display of a Web screen where the input text string is displayed in the search text input text box 301.

In the present embodiment, a case in which a text entry screen is activated on the wireless terminal 15 after activating a text entry screen such as a software keyboard on the TV receiver 1 has been described. In FIG. 11, the text entry screen on the wireless terminal 15 can be directly activated by tapping the “text input” button 213 on the wireless terminal 15 of FIG. 7 without activating the text entry screen on the TV receiver 1 after selecting the search text input text box using the input device 6.

In this way, in a case where search characters are entered into a Web content on the TV screen, the characters can be entered easily at the wireless terminal

Furthermore, in the description of the present embodiment, it is assumed that search candidate list information is received from a server at a search site. Search candidates can also be obtained from the basic dictionary 2009 and the history dictionary 2010 possessed by the TV receiver 1 or from the basic dictionary 2007 and history dictionary 2008 possessed by the wireless terminal 15. Since the wireless terminal 15 can access the external network 14 via the communication I/F 16, search candidate list information can be derived from the server of the search site directly without via the TV receiver 1. Because of this configuration, the amount of traffic between the TV receiver 1 and the wireless terminal 15 can be reduced or the time that would normally be taken for the TV receiver 1 to obtain a search candidate list from a server can be eliminated. Consequently, it is possible to display search candidates on the wireless terminal 15 quickly.

### Embodiment 3

A third embodiment (embodiment 3) associated with the present invention is hereinafter described by referring to FIGS. 1A, 2A, 3D, 3E, 4A, 4D, 6A, 7, 8A, 10, and 16-18. The following description of the present embodiment is made by emphasizing the difference in comparison with the first embodiment.

### System Configuration

In the present embodiment, the network terminal system is identical with its counterpart of the first embodiment and so its description is omitted.

### Software Configuration

In the present embodiment, the software configuration is identical with its counterpart of the second embodiment and so its description is omitted.

### Example of Screen Display

An example of a screen display provided in a case where the input device 6 is manipulated by the user, a Web content is displayed on the TV receiver 1, and characters are entered into the text box of the Web screen is described.

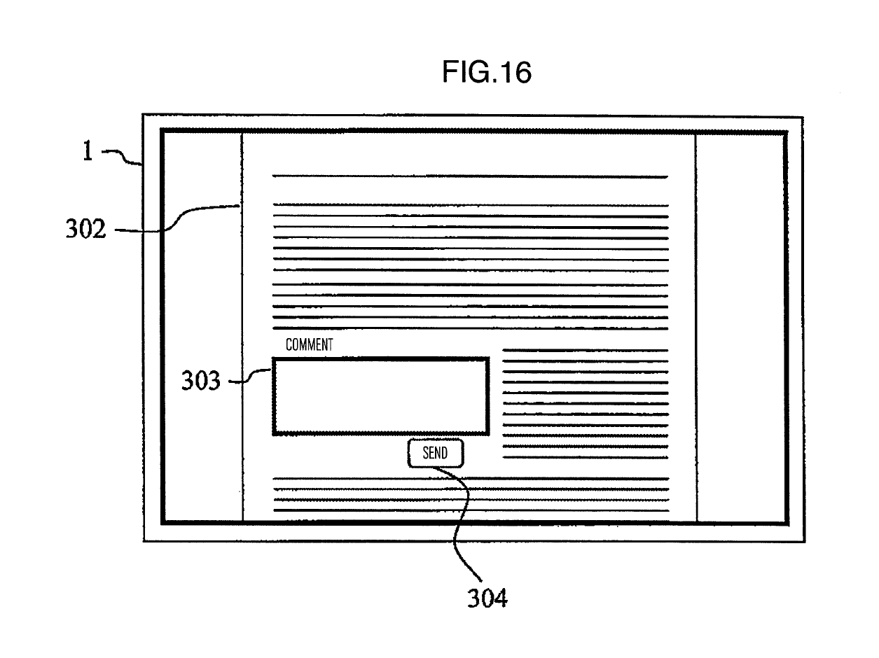

FIG. 16 shows an example in which characters are entered into the text box of a Web content screen displayed on the TV receiver 1. When the input device 6 activates a browser in response to a user's manipulation, the browser engine 2102 accesses the URL of a site that has been previously set as a homepage and displays a browser screen 302 on the display unit 11 of the TV receiver 1.

Then, a case in which characters are entered when the input device 6 is manipulated by the user and a comment is entered into a Web content is described.

In FIG. 16, plural lines of text can be entered as a comment into a text box 303. When the text box 303 is selected using the input device 6, the control unit 4 instructs the text input portion 2004 to display a text entry screen 250 of a software keyboard as shown in FIG. 6A on the display unit 11.

Referring to FIG. 6A, a string of characters that the user want to have can be created in a text input field 206 using numeric keys 207 through the input device 6 in the same way as in the first embodiment. A case in which characters are entered from the wireless terminal 15 is next described.

Referring to FIG. 7, when the “text input” button 213 is tapped, steps S1000 to S1003 of the operational sequence illustrated in FIG. 4A are performed to display a text entry screen 214 as shown in FIG. 8A on the display device 19 of the wireless terminal 15. At the same time, the control unit 17 performs step S1006 of the operational sequence of FIG. 4D to request the TV receiver 1 to obtain the attributes of the displayed text string. The control unit 4 sends back settable conditions such as entry form and character type derived by the browser engine 2102 from a connected site to the wireless terminal 15 as displayed text string attribute information as shown in FIG. 3D.

The displayed text string attributes shown in FIG. 3D indicate that the entry form 101 specifies 2 lines×16 characters and that effective character types 102 include the kanji character set and the two-byte and single-byte alphanumeric character sets. When a string of characters exceeding 16 characters per line is entered, for example, and the “send” button 220 is tapped, the control unit 17 can display an error message and issue an alarm to the user, denoting that the character number limit is exceeded.

Furthermore, where the attributes of the string of the displayed characters indicate that the entry form 101 consists of 1 line×20 characters and the effective character types 102 include kanji character set and two-byte and single-byte alphanumeric character sets as shown in FIG. 3B, if a string of characters including plural lines having a line feed code is entered, the text string up to the line feed code can be made effective according to priorities. Alternatively, the line feed code may be nullified and the full string of characters can be made effective. Priorities are previously stored in the text input portion 2004 for individual cases.

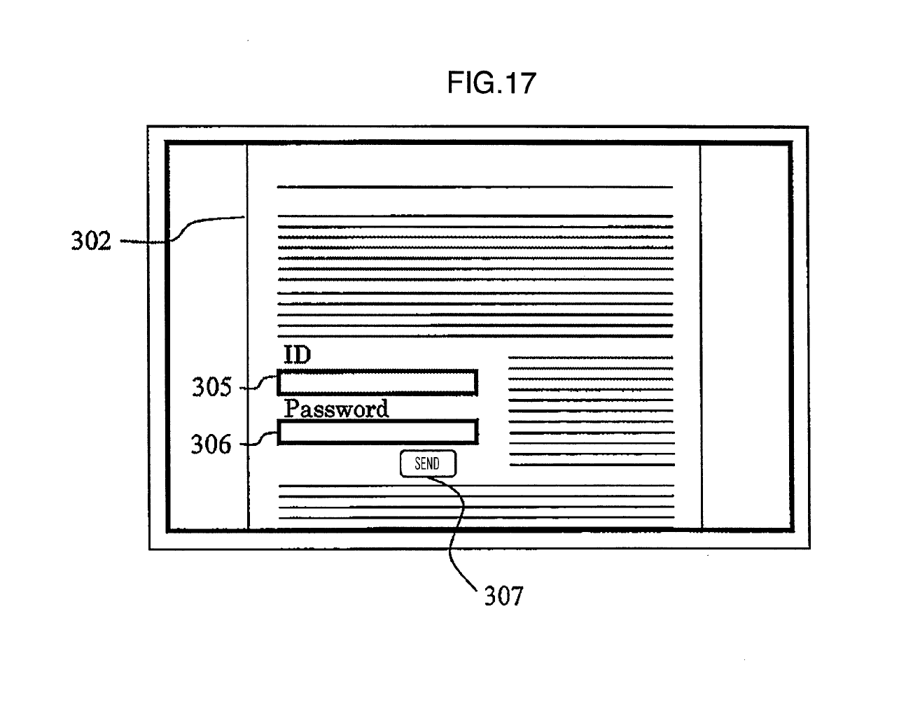

FIG. 17 shows an example of entry of characters in which an ID or password for the text box of a Web content screen displayed on the TV receiver 1 is entered.

When the input device 6 is manipulated by the user and a transition is made from a page having a Web content to a security-protected page, an ID input text box 305 and a password input text box 306 are displayed. In the present embodiment, with respect to the ID or password, the effective character type 102 is specified as the single-byte alphanumeric character set as shown in FIG. 3E to restrict character kinds that can be entered. The input type 103 indicates a password or the like. In the case of a password, the entered text string is replaced by symbols such as asterisk (*) and displayed. Inputting of special characters and symbols such as <, >, @, &, $, * and so on can be inhibited by expanding the data format and specifying certain inhibited characters and symbols.

A case in which characters are entered into the password input text box 306 is next described.

When the password input text box 306 is selected through the input device 6, the control unit 4 instructs the text input portion 2004 to display the text entry screen 250 of the software keyboard shown in FIG. 6A on the display unit 11.

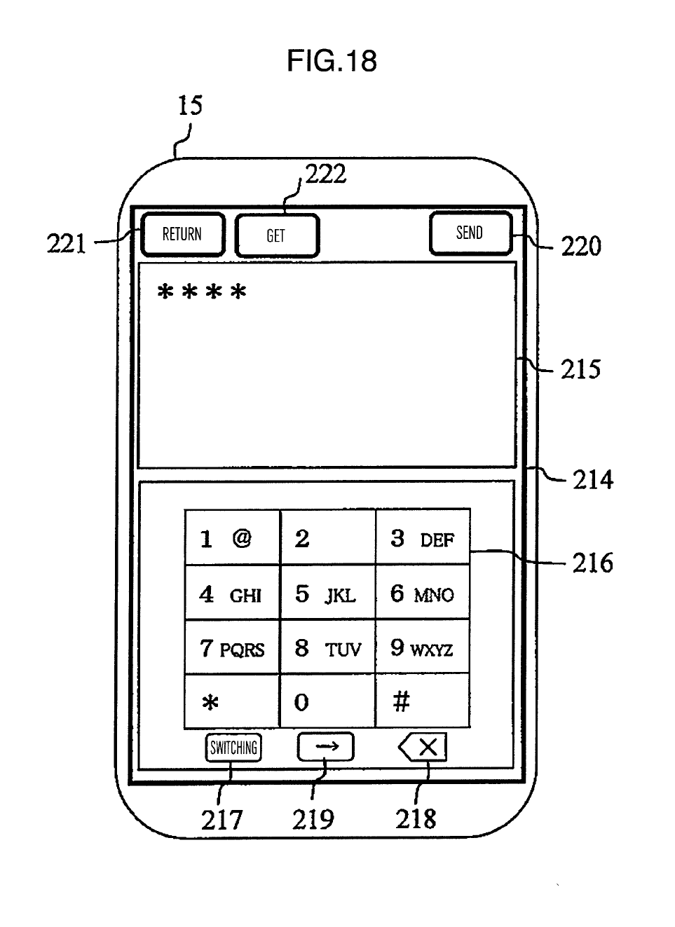

Referring next to FIG. 7, when the “text input” button 213 is tapped, steps S 1000 to S1003 of the operational sequence illustrated in FIG. 4A are performed to display a text entry screen 214 as shown in FIG. 18 on the display device 19 of the wireless terminal 15. At the same time, the control unit 17 requests the TV receiver 1 to obtain the attributes of displayed text string (step S1006 of the operational sequence of FIG. 4D). The control unit 4 sends back settable conditions such as entry form and character types obtained from a connected site by the browser engine 2102 to the wireless terminal 15 as displayed text string attribute information as shown in FIG. 3E.

The input type 103 indicates a password type. When characters are entered using the numeric keys 216, actually entered characters are replaced by asterisk (*) and displayed.

FIG. 18 shows an example of display of text entry screen provided when a password is entered at the wireless terminal 15. In FIG. 18, in a case where the input type 103 of the attributes of a displayed text string is of the password type, a predictive conversion-derived candidate display portion 223 as shown in FIG. 8B illustrating the first embodiment can inhibit the text string from being displayed for security purposes. The entered string of characters can be prevented from being stored in the history dictionaries 2008 and 2010 also for security purposes.

In the present embodiment, an example in which characters are replaced by asterisk (*) has been described. They may also be replaced by a certain character, symbol, or graphical figure.

Characters are entered into the ID input text box 305 by a method that is identical with the method described in connection with FIG. 16 and so its description is omitted.

Where an ID or password is entered into a Web content on a TV screen in this way, characters can be entered at the wireless terminal while securing security.

### Embodiment 4

A fourth embodiment (embodiment 4) associated with the present embodiment is hereinafter described with reference to FIGS. 1A, 2A, 3C, 4B, and 19-26. The following description of the present embodiment is made by emphasizing the difference in comparison with the first embodiment.

### System Configuration

In the present embodiment, the network terminal system is identical with its counterpart of the first embodiment and so its description is omitted.

### Software Configuration

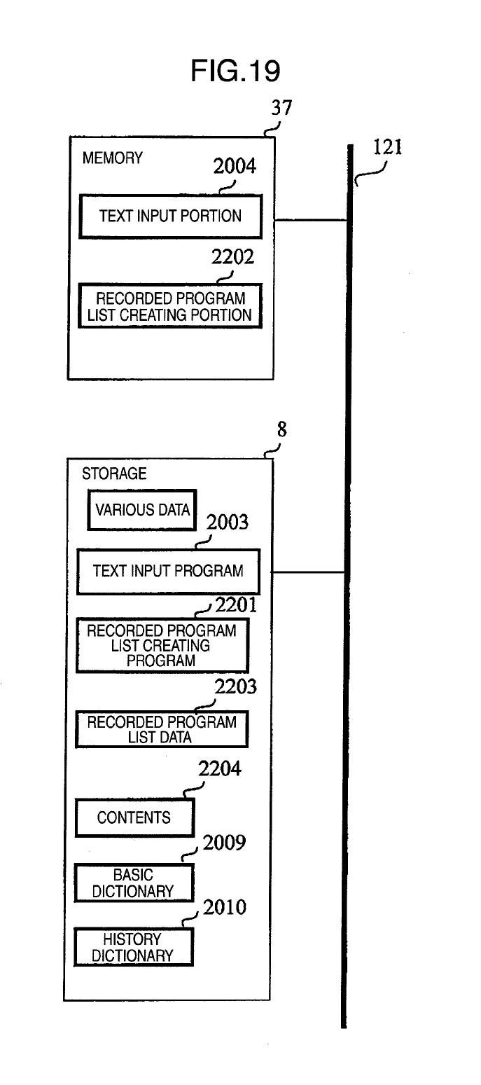

FIG. 19 shows examples of recorded program list creation program functions and text input program functions of the TV receiver 1. In FIG. 19, only the storage 8 and memory 37 of the structure of the TV receiver 1 are shown. FIG. 19 shows the state in which a recorded program list creating program 2201 and a text input program 2003 are stored in the storage 8 and that the control unit 4 has loaded the recorded program list creating program 2201 and the text input program 2003 into the memory 37 as a recorded program list creating portion 2202 and a text input portion 2004, respectively. Furthermore, the storage 8 contains a basic dictionary 2009, a history dictionary 2010, contents 2204, and recorded program list data 2203.

The contents 2204 include programs recorded by scheduled recordings. The recorded program list data 2203 include recorded program list information created by the recorded program list creating portion 2202. The recorded program list information is used to array recorded programs in the order of title or recorded date and time and to display them as a list. Each recorded program includes information about program title, recorded channel, starting and ending times of recording, and details of the program.

The recorded program list data 2203 may be stored as a part of one content 2204 or as an independent data set. The recorded program list creating program 2201 and text input program 2003 may be stored in the storage 8 at the time of shipment of the product or may be downloaded via the communication I/F 12 or via digital broadcast airwaves. Functions implemented by the recorded program list creating portion 2202 of the TV receiver 1 are described below.

### Example of Screen Display

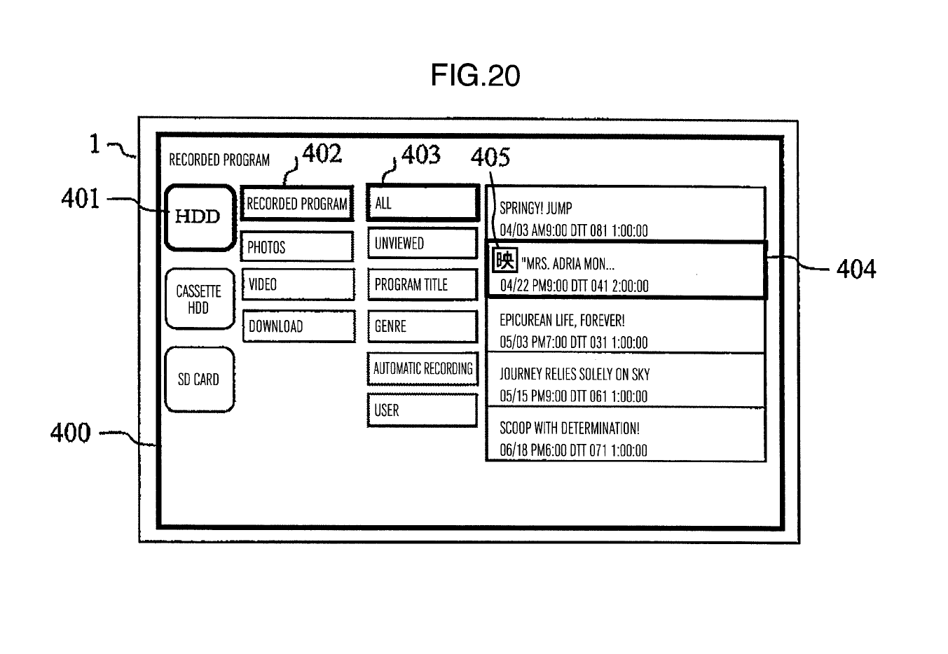

An example in which program titles are modified is described, the program titles being included in a list of recorded programs for playing back recorded programs that are the contents 2204 stored in the storage 8 of the TV receiver 1 by scheduled recording of programs. Upon receiving an instruction for activating a list of recorded programs through the input device 6, the control unit 4 refers to the recorded program list data 2203 in the storage 8 and passes recorded program list information to the recorded program list creating portion 2202, which in turn displays a “recorded program list” screen 400 shown in FIG. 20 on the display device 19 based on the recorded program list information.

FIG. 20 shows an example of display of the “recorded program list” screen of the

TV receiver 1. Referring to FIG. 20, the “recorded program list” screen 400 consists of a hierarchical structure. The first hierarchical layer is a storage medium selecting layer consisting of cells (choices) of HDD, cassette, and SD card. The second hierarchical layer is a storage kind selecting layer consisting of cells of recorded programs, photos, video, and downloading. The third hierarchical layer consists of a category selecting layer including cells of “all”, “unviewed”, “program titles”, and “genre”. The fourth hierarchical layer is a program title selecting layer.

When a cell displaying a program title is selected, the recorded program can be played back based on recorded program identification information for identifying the recorded program of that recorded program title.

FIG. 20 shows the state in which a recorded program title 404 that the user wants to change is selected through the input device 6 by selecting a “HDD” cell 401 of the storage medium selecting hierarchical layer, a “recorded program” cell 402 of the storage type selecting hierarchical layer, and an “all” cell 403 of the category hierarchical layer in this order.

Referring still to FIG. 20, the recorded program title 404 shows an ideographic symbol 405 (indicating cinema), followed by a program title. The program title is displayed as “Mrs. Adria with . . . ”. The program title is displayed using program title information of the service information (SI). Each circled character such as the ideographic symbol 405 is defined by standards of the above-described ARIB.

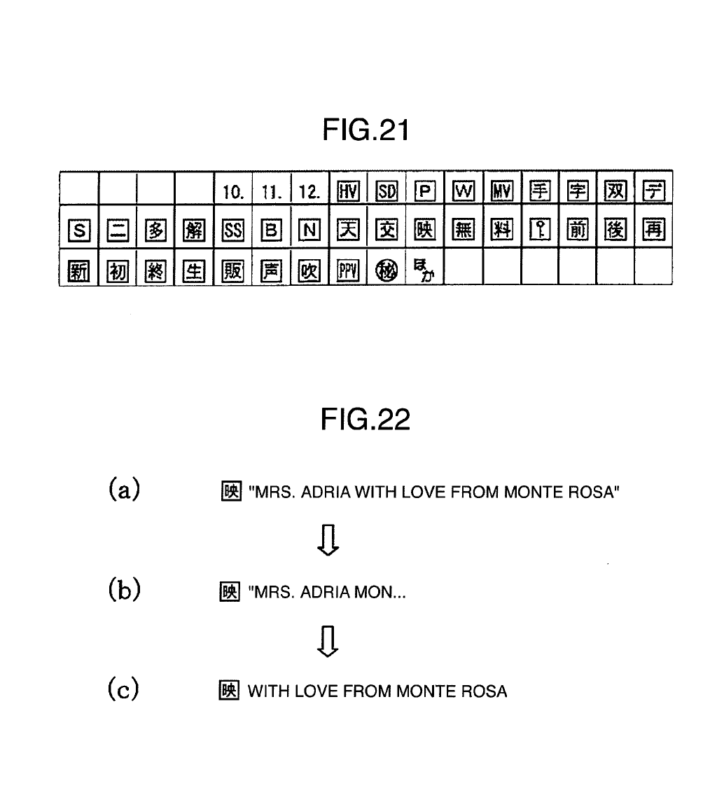

FIG. 21 shows one example of ARIB additional character defined by the ARIB standards. The ARIB additional character set is a collection of external characters excluding JIS X 0208 and used for FM multiplex telecasting, subtitle broadcasting, and program guides. The character set is normalized by ARIB STD-B24 “Data Coding and Transmission Specification for Digital Broadcasting” and by ARIB STD-B3 “ARIB Standards for Operation of FM Multiplex Telecasting System”.

In the present embodiment, it is assumed that ARIB additional characters such as circled characters are installed in the TV receiver 1 and in the wireless terminal 15. An embodiment in which they are not installed in the wireless terminal 15 is described in embodiment 5 later.

FIGS. 22A-22B show an example of original program title contained in the service information (SI) and an example of actually displayed program title. FIG. 22A shows an example of original program title contained in program service information (SI). FIG. 22B shows an example of actually displayed program title. The original program title is “(an ideographic symbol 405: indicating cinema) Mrs. Adria with love from Monte Rosa”. In practice, because of a limitation on the number of displayed characters, the title is shortened and displayed as “(an ideographic symbol 405: indicating cinema) Mrs. Adria Mon . . . ”. The last character of the shortened text string is replaced by “. . . ” indicating that there are following characters.

A case in which the program title is changed from “ (an ideographic symbol 405: indicating cinema) Mrs. Adria Mon . . . ” to “(an ideographic symbol 405: indicating cinema) with love from Monte Rosa” shown in FIG. 22C is now described.

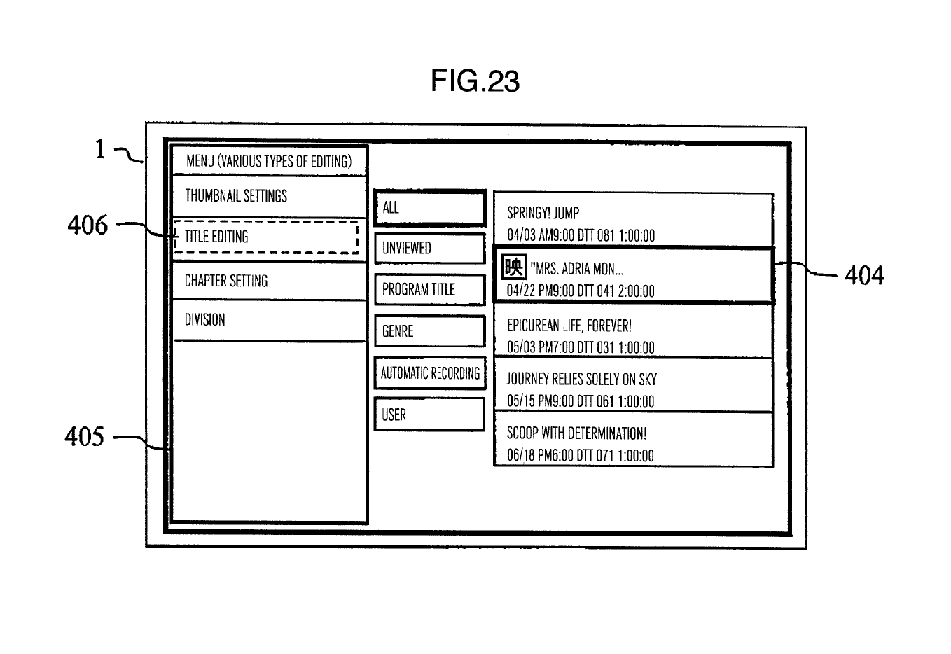

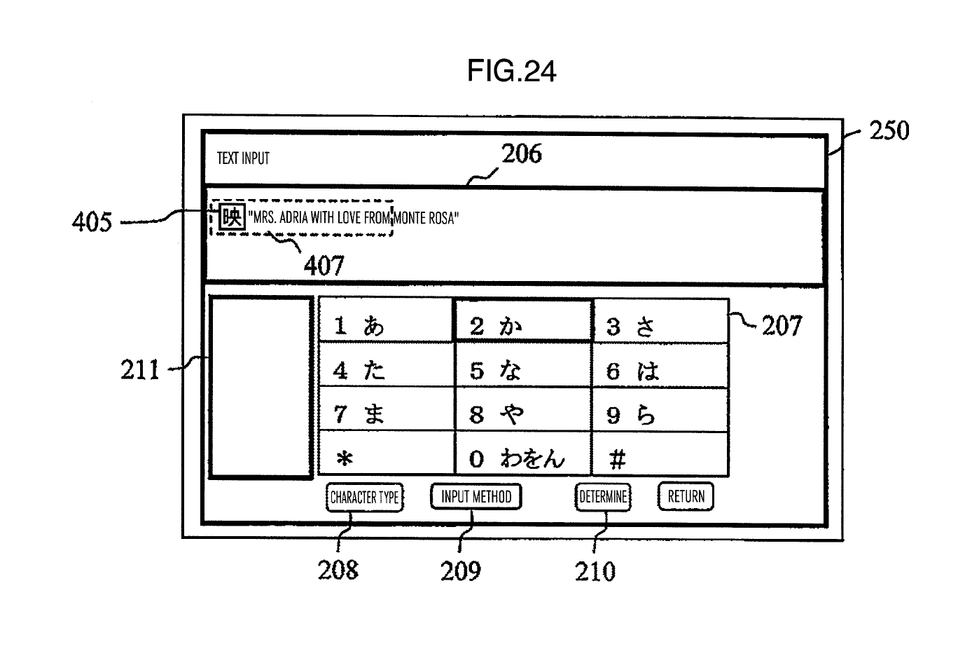

FIG. 23 shows an example of menu choice screen for title editing. When the recorded program title 404 is selected through the use of the input device 6 as shown in FIG. 20 and a menu item 405 for various editing actions as shown in FIG. 23 is selected, the control unit 4 instructs the text input portion 2004 to display a text entry screen 250 of the software keyboard shown in FIG. 24 on the display unit 11. Furthermore, the control unit 4 obtains the program title of the selected recorded program from the service information (SI) stored in the recorded program list data 2203 and passes the title to the text input portion 2004. The text input portion 2004 displays the program title, which has been obtained from the control unit 4, in a text input field 206.

FIG. 24 shows an example of display of the text entry screen on the TV receiver 1 associated with the fourth embodiment. In FIG. 24, the original program title shown in FIG. 22A is displayed in the text input field 206. An effective character display 407 of an actually displayed text string according to the limitation on the number of displayed characters on the “recorded program list” screen 400 is indicated by a frame denoted by the broken line. The effective character display 407 may be other than a frame denoted by a broken line. For instance, the display 407 may be distinguished from other characters by varying the background color or character color. A case in which characters are entered from the wireless terminal 15 is next described.

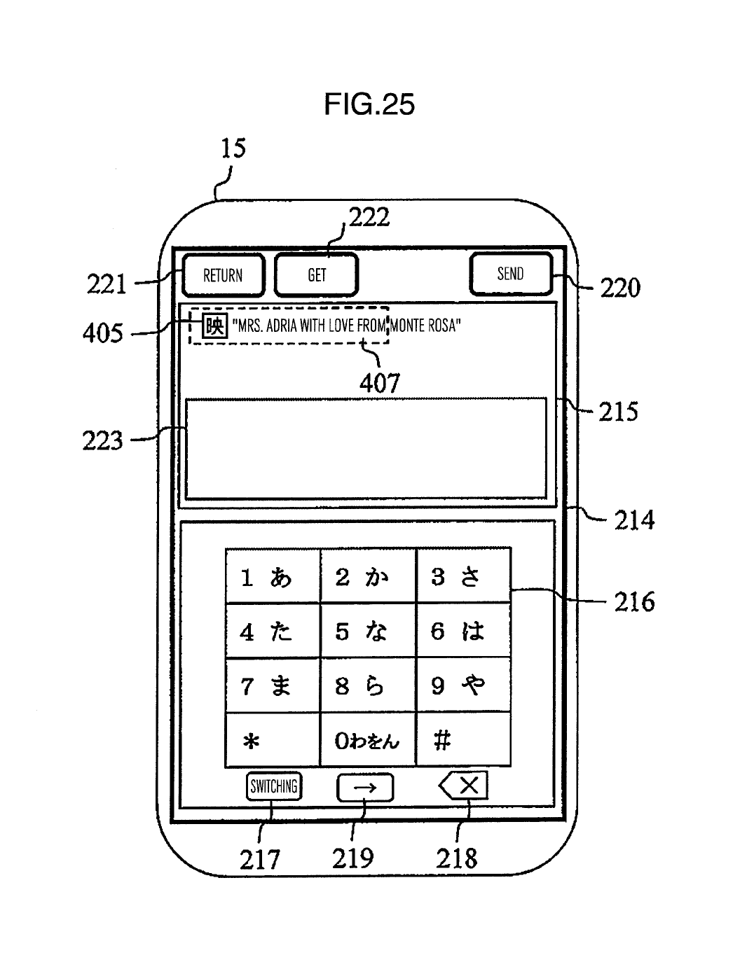

In FIG. 7, when the “text input” button 213 is tapped using the input device 20, steps S2004 to S2005 of the operational sequence of FIG. 11 are performed to display the text entry screen 214 as shown in FIG. 25 on the display device of the wireless terminal 15. As in the above-described modified embodiment of FIG. 4A, the text entry screen 214 of the wireless terminal 15 can be displayed in an interlocking manner with activation of the text entry screen 250 of the TV receiver 1 by omitting tap action on the “text input” button 213 displayed on the menu screen of the wireless terminal 15. In this case, either method may be selected from setting menu choices in the menu screen.

FIG. 25 shows an example of display of text entry screen displayed on the wireless terminal 15 associated with the fourth embodiment.

In FIG. 25, a text string that is identical with the text string displayed on the text input field 206 of FIG. 24 is displayed in the text input field 215. The text string information shown in FIG. 3C and attribute information about the displayed text string is sent from the TV receiver 1. Since the input type 103 indicates a “shortened expression form”, the actually displayed string of characters according to the limitation on the number of displayed characters contained in the text string attribute information is displayed as the effective character display 407 indicated by a frame denoted by a broken line. The effective character display 407 may be other than a frame denoted by a broken line. For instance, the display 407 may be distinguished from other characters by varying the background color or character color.

In FIG. 25, when the “send” button 220 of the text entry screen 214 is tapped, the operational sequence illustrated in FIG. 4B is performed to send the text string of the program title entered into the text input field 215 of the wireless terminal 15 to the TV receiver 1.

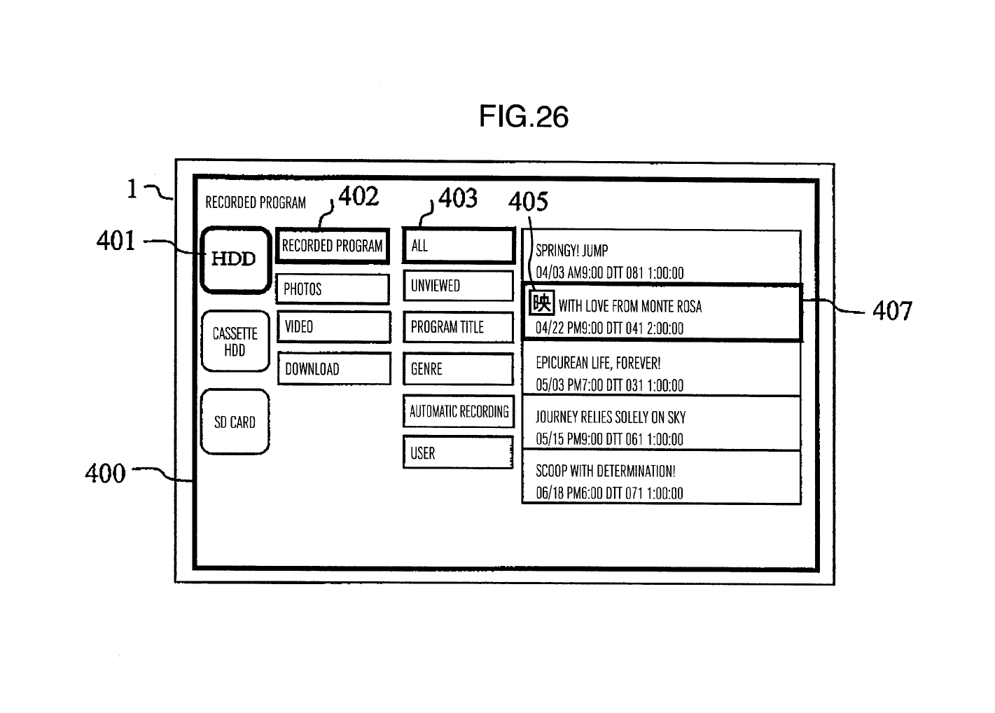

FIG. 26 shows an example of display of the recorded program title 407 modified in the “recorded program list” screen 400.

In this way, unwanted characters of the program title can be deleted or modified to a favorite title on the wireless terminal side regarding the recorded program titles in the recorded program list on the TV screen.

### Embodiment 5

A fifth embodiment (embodiment 5) associated with the present invention is hereinafter described with reference to FIGS. 1A, 4A, 25, 26, and 27. The following description of the present embodiment is made by emphasizing the difference in comparison with the fourth embodiment.

Since the fifth embodiment is similar in system configuration, software configuration, and screen display example with the fourth embodiment, their description is omitted.

In the description of the fourth embodiment, the ARIB additional characters such as circled characters are installed in the TV receiver 1 and in the wireless terminal 15. As described previously, the ARIB additional characters are defined by the ARIB standards. Where the wireless terminal 15 is compliant with subtitle broadcasting and program service information, ARIB additional fonts are installed normally. Where the terminal is not compliant with them, the ARIB additional fonts may not be installed. In the present embodiment, a case in which no ARIB additional fonts are installed in the wireless terminal 15 is described.

In the fourth embodiment, in a case where the wireless terminal 15 is not compliant with the ARIB additional fonts, the wireless terminal 15 cannot display the ARIB additional characters and so it is necessary to disregard the ideographic symbol 405 indicating cinema and shown in FIG. 25 or to replace it with a space. Therefore, if a string of characters is edited by the wireless terminal and then routed to the TV receiver 1, there is the problem that the ideographic symbol 405 indicative of cinema and shown in FIG. 26 is deleted or replaced by a space.

The present embodiment implements a modification of the operational sequence illustrated in the first embodiment in connection with FIG. 4A. That is, a request for obtaining ARIB additional fonts is generated at the timing when a request for obtaining a string of characters is generated at step S1002, thus obtaining the ARIB additional fonts.

### Operational Sequence

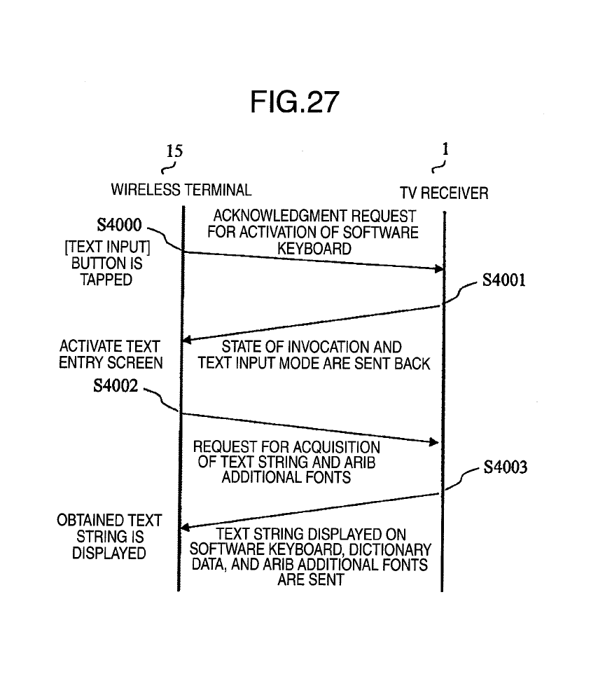

FIG. 27 shows one example of operational sequence performed in a case where the software keyboard is activated by the wireless terminal 15 as a modification of the operational sequence illustrated in FIG. 4A. In FIG. 27, when the “text input” button displayed on the display device 19 is tapped by the input device of the wireless terminal 15, the text input portion 2004 sends an acknowledgment request to the control unit 4 of the TV receiver 1 via the communication I/F 16 of the wireless terminal 15 to see if the software keyboard is activate (S4000).

The text input portion 2002 of the TV receiver 1 gives a notice of the state of activation and the text input mode (program title editing, in this example) via the communication I/F 12 to the control unit 17 of the wireless terminal 15 (S4001).

The control unit 17 of the wireless terminal 15 receives the notice from the control unit 4 of the TV receiver 1. Since the software keyboard of the TV receiver 1 is active, the control unit 17 instructs the text input portion 2002 to activate the software keyboard and displays the text entry screen.

Since the text input mode is program title editing, the control unit 17 of the wireless terminal 15 recognizes that ARIB additional fonts are needed, and requests the TV receiver 1 to obtain text string data and ARIB additional fonts through the communication I/F 16 of the wireless terminal 15 (S4002). The control unit 4 sends the text string data about characters already entered to the software keyboard displayed on the display unit 11, data in the basic dictionary 2009 and history dictionary 2010, and data about the ARIB additional fonts to the control unit 17 of the wireless terminal 15 via the communication I/F 12 (S4003).

Once the ARIB additional font data is obtained, the control unit 17 can refrain from requesting for acquisition of ARIB additional fonts at step S4002 in the second and subsequent sessions such that the ARIB additional fonts are not acquired.

In this way, even where a wireless terminal not compliant with special external characters such as ARIB additional fonts is used, it is possible to enter or edit a text string such as a program title including ARIB additional characters.

### Embodiment 6

A sixth embodiment (embodiment 6) associated with the present invention is hereinafter described with reference to FIGS. 4A, 4B, 24, 26, and 28. The following description of the present embodiment is made by emphasizing the difference in comparison with the fifth embodiment.

The sixth embodiment is similar in system configuration, software configuration, and screen display example with the fifth embodiment and so their description is omitted.

In the fifth embodiment, an example in which ARIB additional fonts are obtained from the TV receiver 1 in a case where the wireless terminal 15 does not have ARIB additional fonts such as circled characters has been described. In the present embodiment, a case in which the wireless terminal cannot obtain ARIB additional fonts nor expand font information is described.

In the present embodiment, in a case where the text string includes an ARIB additional font (such as the aforementioned “cinema” ideogram), a symbol (such as double quotation marks) not usually used in titles are attached to the additional font, the additional font is converted into a standard character and sent to the wireless terminal 15. The TV receiver reconverts the standard character which has been edited by the wireless terminal 15 or has a symbol (such as double quotation marks) attached thereto into the ARIB additional font.

### Operational Sequence

Referring to FIG. 4A, when the “text entry” button displayed on the display device 19 is tapped through the input device of the wireless terminal 15 in the same way as in the first embodiment, the text input portion 2004 sends an acknowledgment request to the control unit 4 of the TV receiver 1 via the communication I/F 16 of the wireless terminal 15 to see if the software keyboard is active (S1000).

The text input portion 2002 of the TV receiver 1 gives a notice of the state of activation to the control unit 17 of the wireless terminal 15 via the communication I/F 12 (S1001).

The control unit 17 of the wireless terminal 15 receives the notice from the control unit 4 of the TV receiver 1. Because the software keyboard of the TV receiver 1 is active, the control unit 17 instructs the text input portion 2002 to activate the software keyboard and displays the text entry screen.

Then, the control unit 17 of the wireless terminal 15 request the TV receiver 1 to obtain text string data via the communication I/F 16 of the wireless terminal 15 (S1002). If characters have been already entered to the software keyboard displayed on the display unit 11 as shown in FIG. 24, the control unit 4 converts the ARIB additional font (i.e., the ideographic symbol 405 denoting cinema) indicated by the text string data into its standard font and sends the text string data including data indicative of the converted font and the data in the basic dictionary 2009 and the history dictionary 2010 to the control unit 17 of the wireless terminal 15 via the communication I/F 12 (S1003).

The control unit 17 instructs the text input portion 2002 to display the received text string on the text entry screen of the software keyboard displayed on the display device 19.

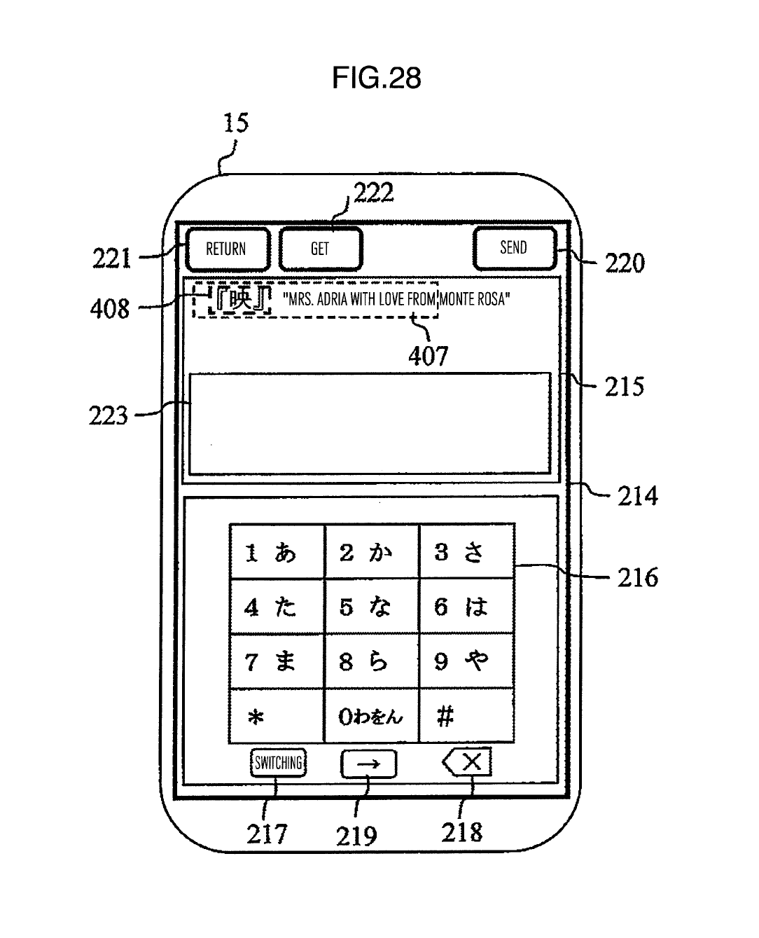

FIG. 28 shows an example of display of the text input screen displayed on the wireless terminal 15 as a modification of the character screen of FIG. 25. In FIG. 28, the ARIB additional font indicated by the text string data about the ideographic symbol 405 indicating cinema and shown in FIG. 25 is displayed as a standard font 408 indicative of “cinema”.

Referring next to FIG. 4B, the text input portion 2002 of the wireless terminal 15 enters characters into the text entry screen of the software keyboard while referring to the basic dictionary 2007 and history dictionary 2008, based on a user's manipulation accepted by the input device 20, in the same way as in the first embodiment. Then, if the “send” button displayed on the display device 19 is tapped to determine the character entered into the wireless terminal 15, the text string data entered into the text entry screen of the software keyboard of the wireless terminal 15 and the data in the basic dictionary 2007 and history dictionary 2008 referenced during entry of characters are sent to the control unit 4 of the TV receiver 1 from the control unit 14 via the communication I/F 16 (S1004).

The control unit 17 closes the text entry screen of the software keyboard displayed on the display device 19. The control unit 4 of the TV receiver 1 receives the text string data and the data in the basic dictionary 2007 and history dictionary 2008 from the wireless terminal 15, converts the standard character enclosed within double quotation marks contained in the text string received from the wireless terminal 15 into an ARIB additional font, closes the text entry screen of the software keyboard, returns to the previous screen, and finalizes the entry of the characters as shown in FIG. 26.

Each symbol consisting of a character enclosed within a square or round frame can be displayed on the wireless terminal 15 by attaching double quotation marks to the character included inside the symbol. Similarly, an ideographic symbol 405a enclosed within a square mark and meaning a key can be displayed on the wireless terminal 15 by enclosing an ideographic symbol “key” in double quotation marks. A string 405b of characters arrayed obliquely and meaning “other” can be displayed on the wireless terminal 15 by enclosing the “other” in double quotation marks.

With respect to each of marks 405c, 405d, and 405e, it can be enclosed in double quotation marks. Alternatively, numerals and a period contained in it can be replaced by single-byte characters as they are. This kind of display can reduce the differences with the display provided on the TV receiver 1.

In the present embodiment, a font enclosed within double quotation marks is treated as an external character font. Instead, other symbol that is not usually used for program titles or used infrequently may be used.

In this way, even when a wireless terminal which is not compliant with special external characters such as ARIB additional characters and which cannot expand font information by obtaining external character fonts is used, a text string including an ARIB additional character in a program title can be entered or edited.

When a string of characters including a kanji character enclosed in double quotation marks is entered to the wireless terminal 15 and the TV receiver 1 does not have any external font corresponding to this kanji character, (i) this kanji character enclosed in double quotation marks is displayed as it is, (ii) the double quotation marks are converted into single quotation marks and the kanji character enclosed in single quotation marks is displayed, or (iii) an error code indicating that outputting is not possible is displayed instead of the kanji character enclosed in double quotation marks.

In the present embodiment, an example in which the TV receiver 1 converts and outputs an external or additional font to the wireless terminal 15 has been described.

Alternatively, the conversion and outputting as described above can be done by sending the external character font as it is at S1003 in the same way as in embodiment 1 from the TV receiver 1 and causing the text input portion 2002 of the wireless terminal 15 to have conversion tables for external font codes and standard font codes. In this case, even where a wireless terminal which is not compliant with special external characters such as ARIB additional characters and which cannot expand font information by obtaining external character fonts is used, it is possible to enter or edit a text string including ARIB additional characters which are included, for example, in program titles.

### Embodiment 7

A seventh embodiment (embodiment 7) associated with the present invention is hereinafter described with reference to FIGS. 1A, 2A, 12-15, and 29-31. The following description of the present embodiment is made by emphasizing the difference in comparison with the second embodiment.

The seventh embodiment is similar in system configuration and software configuration with the second embodiment and so their description is omitted.

In the second embodiment, a case in which the TV receiver 1 activates a text entry screen of a software keyboard and then the wireless terminal 15 activates a text entry screen has been described. In the present embodiment, a case in which a text entry screen is activated from the wireless terminal 15 is described.

### Operational Sequence

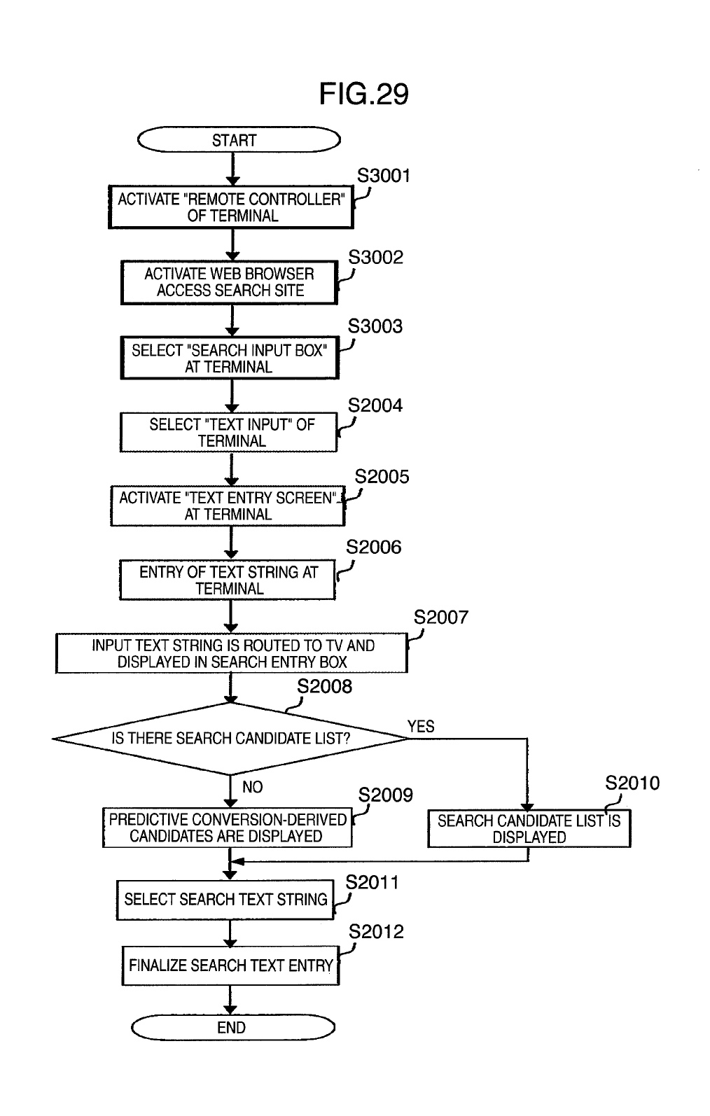

FIG. 29 illustrates one example of operational sequence performed when a software keyboard is activated by a wireless terminal 15 as one modification of the operational sequence illustrated in FIG. 11, which illustrates the operational sequence of the second embodiment. In FIG. 29, steps S3001 to S3003 correspond to steps S2001 to S2003 of FIG. 11. Also, in contrast with the second embodiment, the control unit 14 has a function of generating control information such as commands for controlling the TV receiver 1.

When an instruction for activating the “remote control” function is received through the input device 20, the control unit 17 of the wireless terminal 15 displays a remote control screen on the display device 19 (S3001).

When the input device 20 is manipulated to activate a “Web browsing” function, the control unit 17 sends an instruction for activating a browser to the control unit 4 of the TV receiver 1 via both communication I/F 16 and communication I/F 12. Upon receiving the instruction for browser invocation, the control unit 4 activates the browser engine 2102. The browser engine 2102 creates a browser screen and displays a Web content screen on the display unit 11 in the same way as in embodiment 2 (S3002).

Then, a search text input text box of a search site is selected using the input device 20 of the wireless terminal 15 (S3003). The following steps S2004 to S2012 are similar to the steps of the operational sequence illustrated in FIG. 11 and so their description is omitted.

### Example of Screen Display

A case in which the input device 20 is manipulated by the user and characters are entered into the search text input text box while displaying a Web content on the TV receiver 1 is next described while taking an example of screen display.

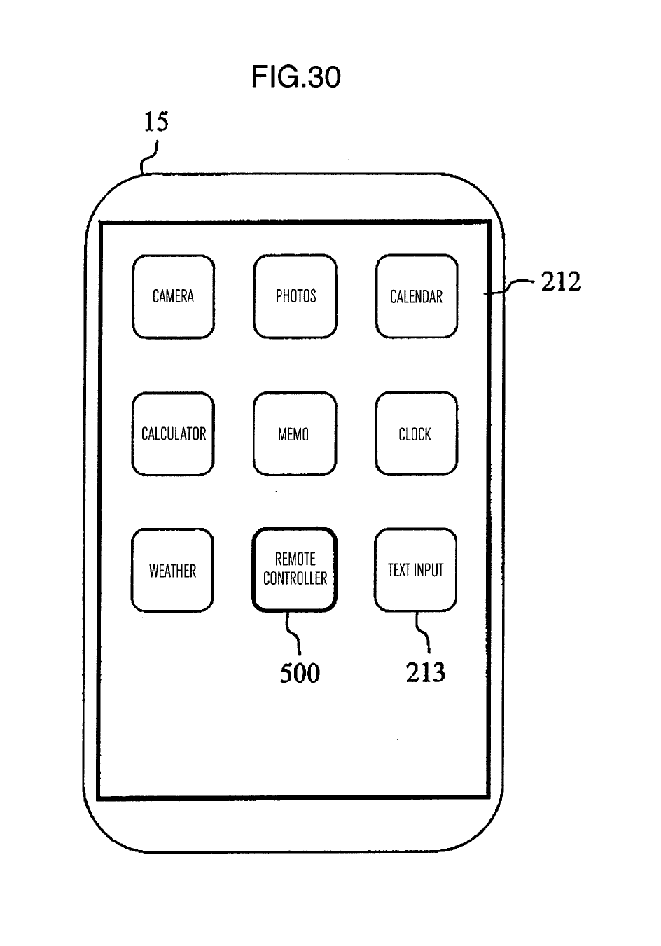

FIG. 30 shows an example of display of a menu screen 212 on the wireless terminal 15. The difference with the second embodiment illustrated in FIG. 7 is that a “remote control” button 500 is added instead of “stocks (share)” button of FIG. 7.

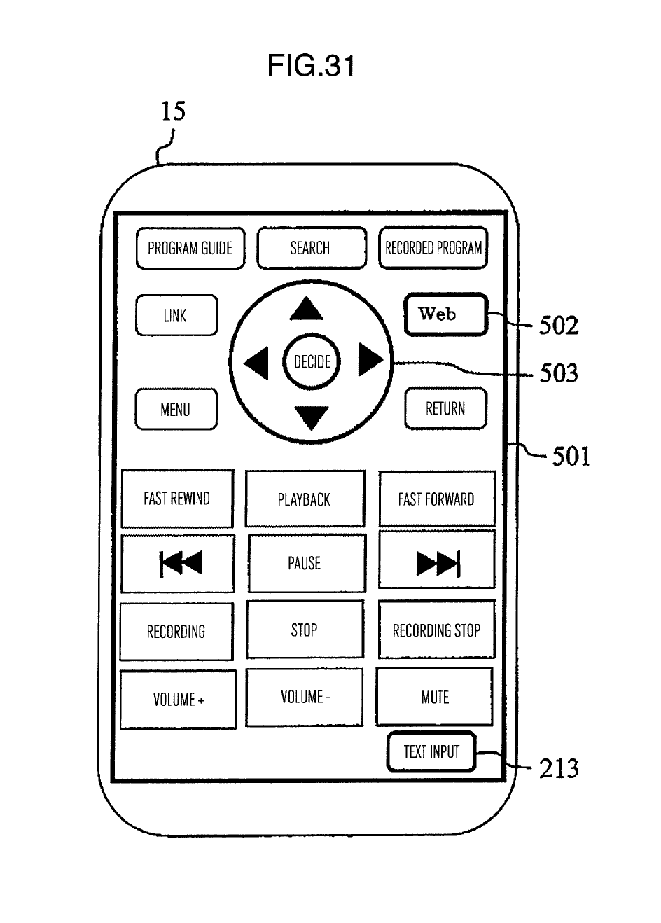

FIG. 31 shows an example of display of a remote control screen 501 for the wireless terminal 15. In FIG. 30, when the “remote control” button 500 is tapped, the “remote control” screen 501 as shown in FIG. 31 is displayed. In FIG. 31, when a “Web browser” button 502 on the wireless terminal 15 is tapped, a browser is activated. As an example, the browser accesses the URL of a search site that has been previously established as a homepage, and displays a browser screen 300 as shown in FIG. 12 on the display unit 11 of the TV receiver 1.

If the search text input text box 301 shown in FIG. 12 is selected using a “cursor” control button 503 on the remote control screen 501 shown in FIG. 31, and if the “text input” button 213 shown in FIG. 31 is tapped, the text entry screen 214 as shown in FIG. 13 is displayed.

Search characters are then entered as shown in FIGS. 14 and 15 by the same procedure as the second embodiment. Where search characters are entered into a Web content on the TV screen in this way, characters can be entered at the wireless terminal

It is to be understood that the present invention is not restricted to the above-described embodiments but rather embraces various modifications. For example, the whole system has been described in detail in each embodiment to facilitate understanding the present invention. The invention is not always restricted to ones having all the configurations described. Furthermore, some of configurations of one embodiment can be replaced by configurations of other embodiment. In addition, configurations of some embodiment can be added to configurations of other embodiment. Further, other configurations can be added to some configurations of each embodiment. These some configurations can be deleted or replaced.

Furthermore, the above-described configurations, functions, processing portions, and processing means may be realized in hardware. For example, all or some of them are designed as an integrated circuit. In addition, the above-described configurations and functions may be realized in software by causing a processor to interpret and execute a program that implements those functions. Programs, tables, files, and other information for realizing the functions can be placed in a memory, a hard disk, an SSD (solid-state drive), or other storage device or on a storage medium (such as IC card, SD card, or DVD).

The programs described in the various examples may be independent programs. Plural programs may constitute one application program.

Control lines and information lines which are considered to be necessary for explanation are shown. All control lines and information lines which are necessary for finished products are not always shown. It can be considered that almost all configurations are interconnected in practice.

The embodiments have been described using TV1 and TV2 each having the display unit 11. The present invention can be similarly implemented by an STB or recorder having an external display unit.

It should be further understood by those skilled in the art that although the foregoing description has been made on embodiments of the invention, the invention is not limited thereto and various changes and modifications may be made without departing from the spirit of the invention and the scope of the appended claims.

1. A network terminal system having a display device and a terminal device both connected with a network, the network terminal system further including a text input system;
wherein said display device has a display unit for displaying textual information, first text input means for entering a text string in a text input field of the display unit in which characters can be entered, and first send-receive means for sending or receiving text string information entered from the first text input means to or from the network;
wherein said terminal device has second send-receive means for sending or receiving the text string information sent from the first send-receive means of the display device to or from the network and second text input means for displaying the text string information received by the second send-receive means and entering a text string;
wherein said terminal device sends the text string information entered by the second text input means to the network from the second send-receive means; and
wherein said display device receives the text string information from the network via the first send-receive means and uses the received text string information as a text string entered into the first text input means.

2. The network terminal system of claim 1, wherein said terminal device has means that activates said second text input means in an interlocking manner with activation of said first text input means.

3. The network terminal system of claim 1, wherein said terminal device has input determining means for determining entry of characters performed by said second text input means and sends the text string information determined by the input determining means to the network from the second send-receive means, and wherein said display device has means which receives the text string information from the network via the first send-receive means and determines entry of characters performed by the first text input means using the received text string information.

4. The network terminal system of claim 1, wherein said first text input means gives a notice of information about a text string to which information about attributes of input characters is added to the second text input means to thereby limit the number of characters entered by the second text input means according to the information about the attributes.

5. The network terminal system of claim 4,
wherein said information about the attributes of the text string has information about a shortened expression form, and
wherein said second text input means has means which, when the information about the attributes included in the text string information obtained from said first text input means includes the shortened expression form, displays the text string indicated by the text string information in distinction from a text string section displayed in the shortened expression form.

6. The network terminal system of claim 4, wherein said information about the attributes of the text string has information about a password, and wherein said second text input means displays the text string indicated by the text string information after replacing the text string by a certain character, symbol, or graphical figure when the information about the attributes included in the text string information obtained from said first text input means includes the password.

7. The network terminal system of claim 1, wherein, when said text string information sent to said second text input means contains an unsupported character, said first text input means takes text string information to which character font data about the unsupported character is added as said text string information.

8. The network terminal system of claim 1, wherein
said terminal device has an input device and means for generating control information for selecting a text input field in which said characters can be entered through the input device,
said second send-receive means sends the control information to said display device,
said first send-receive means of said display device receives the control information, and
there is further provided means for selecting the text input field of the display device according to the control information.

9. A terminal device comprising:
a send-receive unit for sending or receiving text input information about a connected device to or from the connected device, and
a text input unit for displaying the text string information received by the send-receive unit and entering a text string,
wherein said text string information entered by said text input unit is sent from said send-receive unit to said connected device.

10. The terminal device of claim 9, wherein said text string information includes information about attributes of each input character, and wherein the number of characters entered by said text input unit is restricted using the information about the attributes.
